(19) United States
(12) Patent Application Publication
(10) Pub. No.: US 2024/0198628 A1
(43) Pub. Date: Jun. 20, 2024

(54) LAYERED AEROGEL COMPOSITES, RELATED AEROGEL MATERIALS, AND METHODS OF MANUFACTURE

(71) Applicant: Aerogel Technologies, LLC, Boston, MA (US)

(72) Inventor: Stephen A. Steiner, III, Milwaukee, WI (US)

(73) Assignee: Aerogel Technologies, LLC, Boston, MA (US)

(21) Appl. No.: 18/354,834

(22) Filed: Jul. 19, 2023

Related U.S. Application Data
(63) Continuation of application No. 14/214,887, filed on Mar. 15, 2014, now abandoned.
(60) Provisional application No. 61/799,460, filed on Mar. 15, 2013.

(51) Int. Cl. B32B 5/26; B32B 5/12; F41H 5/04

(52) U.S. Cl. CPC B32B 5/26; B32B 5/12; F41H 5/0414; F41H 5/0442; F41H 5/0471; B32B 2250/40; B32B 2250/42; B32B 2260/023; B32B 2260/046; B32B 2262/10; B32B 2262/106; B32B 2266/0214; B32B 2307/102; B32B 2307/304; B32B 2571/02; Y10T 428/249921; Y10T 428/24996; Y10T 428/249975; Y10T 428/249981; Y10T 428/249982; Y10T 428/24999; Y10T 428/249991; Y10T 442/3325; Y10T 442/3341; Y10T 442/335; Y10T 442/50; Y10T 442/56; Y10T 442/59; Y10T 442/647; Y10T 442/649; Y10T 442/651

(57) ABSTRACT

Composites comprising aerogel materials are generally described. Layered aerogel composites may be of great utility for a wide variety of applications including lightweight structures, ballistic panels, multilayer thermal and acoustic insulation, spacecraft reentry shielding, supercapacitors, batteries, acoustic insulation, and flexible garments. Layered aerogel composites may be prepared by combing layers of fiber-containing sheets and multisheet plies with aerogel materials. Composites comprising mechanically strong aerogels and reticulated aerogel structures are described. Various nanocomposite aerogel materials may be prepared to facilitate production of composites with desirable functions and properties. Layered aerogel composites and related aerogel materials described in the present disclosure have not been previously possible due to a lack of viable aerogel formulations, a lack of methods for adhering and joining aerogel materials to each other and other materials, and a lack of methods that enable combining of fibrous materials and aerogels into layered structures in the same material envelope. Aerogel composites described herein enable specific capabilities that have not been previously possible with aerogels or through other means, for example, the ability to efficiency slow impacts from bullets and other ballistic bodies using a lightweight (<2 g/cm³ density) material, bear load as structural members at a fraction of the weight of conventional technologies, or simultaneously serve as a structural or flexible material that stores electrical energy.

### CROSS-REFERENCED TO RELATED APPLICATIONS

This application is a continuation of U.S. patent application Ser. No. 14/214,887 filed Mar. 15, 2014, entitled “Layered Aerogel Composites, Related Aerogel Materials, and Methods of Manufacture,” which claims priority to U.S. Provisional Application No. 61/799,460 filed Mar. 15, 2013, entitled “Layered Aerogel Composites, Related Aerogel Materials, and Methods of Manufacture,” the entire contents of each of which are incorporated herein by reference in its entirety.

### BACKGROUND 1. Field

Aspects herein relate to layered composites of aerogel materials and non-aerogel materials (e.g., fibrous sheets and laminates), uses thereof, and methods of preparation. For example, the composites may include mechanically strong composites with multifunctional properties.

2. Discussion of Related Art

Aerogels are a diverse class of low-density solid materials comprised of a porous three-dimensional network of interconnected nanostructures. Aerogels often exhibit a wide array of desirable materials properties including high specific surface area, low bulk density, high specific strength and stiffness, low thermal conductivity, and low dielectric constant, among others. Certain aerogel compositions may combine several of these properties into the same material envelope and may thus be advantageous for applications including thermal insulation, acoustic insulation, lightweight structures, impact damping, electrodes, catalysts and catalyst supports, and sensors.

Laminated fiber-based composites are another class of materials with numerous materials properties advantages including high specific strength and stiffness, tailorable mechanical properties, high specific energy absorption, and in some cases good electrical and thermal conductivity. Laminated composites of various types are used in numerous applications including aerospace structures, boat hulls, bicycle frames, high-performance sports equipment, and aircraft brake pads.

### SUMMARY

The present disclosure relates generally to composites of aerogel materials and non-aerogel materials such as fibrous sheets and/or laminated plies. The inventor has appreciated that by combining certain aerogel materials and non-aerogel materials into laminar configurations, composites with advantages not attainable by either component separately can be achieved. In some cases, the resulting composite, through an effective linear weighted average of the materials properties of the components, enables access to regions of materials parameter space that are otherwise difficult to reach. In other cases, synergistic interactions between the fibrous materials and aerogel materials may arise.

Layered aerogel composites may take many forms and have many different useful advantages. Layered aerogel composites comprising mechanically strong aerogel materials are particularly useful. In some embodiments, layered aerogel composites are particularly well-suited as multilayer insulation (MLI) with better thermal performance than the aerogel material by itself. In some embodiments, layered aerogel composites with good flexibility may serve as useful insulation for garments. In other embodiments, layered aerogel composites are highly effective ballistic materials useful for bullet-proof vests, armored vehicle cladding, and energetic flames or jets. In some embodiments, layered aerogel composites may be useful in space applications including micrometeoroid/space debris protection and vehicle reentry shielding. In further embodiments, layered aerogel composites may serve as high stiffness-to-weight ratio materials suitable for lightweight structures, aircraft and automotive parts, and high-performance sports equipment.

In an embodiment, a structure is provided. The structure includes bonded alternating layers of at least an aerogel material and at least one of a fibrous sheet, a plastic sheet, a plastic plate, a ceramic sheet, a ceramic plate, and a multilayer ply, the multilayer ply comprising multiple fibrous sheets bonded together.

In another embodiment, a structure is provided. The structure includes alternating layers of aerogel material wherein said layers are bonded to each other.

In another embodiment, a structure is provided. The structure includes alternating layers of aerogel material wherein said layers are joined to each other by an array of oriented nanostructures.

In yet another embodiment, a method for fabricating a layered aerogel composite is provided. The method includes providing a first layer, the layer comprising at least a fibrous sheet or a multilayer laminate; applying a second layer to the first layer, the layer comprising an aerogel material; applying a third layer to the second layer, the layer comprising another fibrous sheet or multilayer laminate; bonding or joining the first layer to the second layer; and bonding or joining the second layer to the third layer.

In another embodiment, a method for fabricating a layered aerogel composite is provided. The method includes providing a first layer, the layer comprising at least a fibrous sheet or a multilayer laminate; applying a second layer to the first layer, the layer comprising a liquid-phase gel precursor; applying a third layer to the second layer, the layer comprising another fibrous sheet or multilayer laminate; bonding or joining the first layer to the second layer; and bonding or joining the second layer to the third layer.

In yet another embodiment, a method for fabricating a layered aerogel composite is provided. The method includes providing two layers of aerogel material, each aerogel material exhibiting a modulus greater than about 1 MPa, and bonding the two layers together.

In another embodiment, a method for fabricating a layered aerogel composite is provided. The method includes providing a liquid-phase precursor; contacting with an array of orientated nanostructures; forming a gel from said liquid-phase precursor; and forming a second gel in contact with the array of orientated nanostructures.

In an embodiment, a composition is provided. The composition includes an aerogel and an array of aligned nanostructures embedded within the aerogel.

In another embodiment, a composition is provided. The composition includes an electrically-conductive aerogel material; an electrically insulating coating applied on the electrically-conductive aerogel; and an electrically conducting coating applied on the electrically insulating coating. The aerogel material may have interior contours where the electrically insulating coating is present as a substantially conformal surface layer over said contours, and said electrically conducting coating is substantially conformal over the contours of said electrically insulating coating.

Advantages, novel features, and objects of the present disclosure will become apparent from the following detailed description when considered in conjunction with the accompanying drawings, which are schematic and which are not intended to be drawn to scale. For purposes of clarity, not every component is labeled in every figure, nor is every component of each embodiment shown where illustration is not necessary to allow those of ordinary skill in the art to understand every embodiment.

### BRIEF DESCRIPTION OF THE DRAWINGS

Various embodiments of the present disclosure will now be described, by way of example, with reference to the accompanying figures, in which:

FIG. 1 depicts a spheroidal “string-of-pearls” morphology typical of some gel and aerogel materials in accordance with some embodiments;

FIG. 2 depicts an acicular morphology typical of some gel and aerogel materials in accordance with some embodiments;

FIG. 3 depicts a “worm-like” morphology typical of some gel and aerogel materials in accordance with some embodiments;

FIG. 4 depicts a fibrous morphology typical of some gel and aerogel materials in accordance with some embodiments;

FIG. 5 depicts a sheet-like morphology typical of some gel and aerogel materials in accordance with some embodiments;

FIG. 6 depicts a cross-sectional view of a layered aerogel composite in accordance with some embodiments;

FIG. 7 depicts a cross-sectional view of a layered aerogel composite with multiple alternating layers of fibrous sheets and/or multisheet laminates and/or other non-aerogel material and aerogel material;

FIG. 8 depicts a cross-sectional view of a layered aerogel composite comprising layers which are comprised of multiple layers of fibrous sheets in accordance with some embodiments;

FIG. 9 depicts a cross-sectional view of a layered aerogel composite in which an array of aligned nanostructures is used to reinforce the bond between a fibrous sheet and/or multisheet laminate and/or other non-aerogel material and aerogel material in accordance with some embodiments;

FIG. 10 shows an exploded view of layered aerogel composites comprising single-sheet layers and multisheet layers comprising fibrous sheets with aligned fibers in accordance with some embodiments;

FIG. 11 shows an exploded view of layered aerogel composites comprising single-sheet and multisheet layers comprising fibrous sheets with unoriented fibers in accordance with some embodiments;

FIG. 12 depicts a method for crosslinking a gel or aerogel material to produce a crosslinked gel or aerogel in accordance with some embodiments;

FIG. 13 illustrates examples of reticulated patterns that may comprise some aerogel materials in layered aerogel composites in accordance with some embodiments;

FIG. 14 depicts a cross-sectional view of a layered aerogel composite comprising layers of aerogels directly bonded to each other through various approaches in accordance with some embodiments;

FIG. 15 depicts a gel or aerogel material reinforced by an array of oriented nanostructures in accordance with some embodiments;

FIG. 16 depicts a method for fabricating a layered aerogel composite using perforated fibrous sheets and/or multilayer plies in accordance with some embodiments;

FIG. 17 depicts a method for fabricating a layered aerogel composite using oriented fibrous sheets and/or multilayer plies in accordance with some embodiments;

FIG. 18 depicts a method for fabricating a layered aerogel composite using adhesive in accordance with some embodiments;

FIG. 19 illustrates a general scheme for how fibrous sheets and/or multilayer laminates may be chemically bonded to an aerogel material in accordance with some embodiments;

FIG. 20 shows a photograph of a carbon nanotube sheet being infiltrated (“prepregged”) with an epoxy adhesive in accordance with some embodiments;

FIG. 21 shows a multisheet ply comprised of laminated carbon nanotube sheets bonded to polymer-crosslinked vanadia aerogel in accordance with some embodiments;

FIG. 22 shows a multilayer aerogel composite comprised of alternating layers of mechanically strong aerogel material and carbon nanotube plies suitable for ballistics application in accordance with some embodiments; and

FIG. 23 shows a multilayer aerogel composite comprised of alternating layers of mechanically strong aerogel material bonded to non-aerogel material in accordance with some embodiments.

### DETAILED DESCRIPTION

The present disclosure relates to layered aerogel composites, methods of fabrication, and uses thereof.

Historically, aerogel materials have exhibited numerous drawbacks that have prohibited their use in numerous structural and non-structural applications. Among these drawbacks are poor mechanical properties, e.g., low compressive strength, low compressive stiffness, and poor facture toughness, as well as a propensity to absorb liquids via capillary-driven wetting in a way that damages the aerogel material. Additionally, shaping aerogels has been challenging due to both a lack of machinability and tremendous difficulty in molding desired features (e.g., macroscale reticulated columns) without causing cracking in the aerogel precursor or aerogel, as substantial dimensional changes and/or internal stresses can easily arise.

The inventor has discovered compositing strategies that enable production of mechanically viable, multifunctional layered aerogel composites. Such layered aerogel composites may be of great utility for a wide variety of applications including lightweight structures, ballistic panels, multilayer thermal insulation, spacecraft reentry shielding, supercapacitors, batteries, acoustic insulation, and flexible garments. Layered aerogel composites described herein have not been previously possible due to a lack of viable aerogel formulations, a lack of methods for adhering and joining aerogel materials to each other and other materials, and a lack of methods that enable combining of non-aerogel materials (such as fibrous materials and fiber-reinforced laminates) and aerogels within layered structures into the same material envelope and that also do not prohibit or stifle manufacturing processes such as diffusion-limited steps.

Additionally, many aerogel composites described herein enable specific capabilities that have not been previously possible with aerogels or through other means, for example, the ability to efficiency slow impacts from bullets and other ballistic bodies using a lightweight (<2 g/cm³ density) material, bear load as structural members at a fraction of the weight of conventional technologies, or simultaneously serve as a structural or flexible material that stores electrical energy.

Some aerogel composites described herein achieve such capabilities through synergistic interactions between the aerogel material layers and non-aerogel material layers, for example, through mechanistic interplay between fibers and aerogel nanostructures under high strain rates, or because they simultaneously possess a relatively high compressive modulus and surface functional groups (such as isocyanate, amine, biuret, uretdione, isocyanurate, urethane, urea, amide, acyl urea, imide, oxazolidone, oxadiazinetrione, oxirane, acyl halide, carboxylic acid, or hydroxyl) exposed on aerogel material layers that make possible chemical bonding of non-aerogel materials through application of an adhesive.

Aerogel materials are typically mesoporous (i.e., primarily contain pores ranging from 2-50 nm in diameter) solids that are usually at a minimum of about 50% voidspace by volume and, in some cases, up to 99.98% or greater voidspace by volume. Aerogels are not limited in composition to one particular substance and can in fact be comprised of a wide array of substances including: silica; metal and metalloid oxides; organic polymers; carbon and its various allotropes and morphologies; elemental metals and metalloids; metal and metalloid carbides, nitrides, chalcogenides, and other compounds; assembled nanostructures such as nanotubes (such as carbon nanotubes and boron nitride nanotubes), quantum dots, nanosheets (such as graphene and molybdenum disulfide), and nanoparticles; and other substances.

Aerogels may be produced through the sol-gel process by preparing a solution of reactive monomers or a dispersion of pre-fabricated particles that can undergo agglomeration (sometimes a sol, but generically a “liquid-phase aerogel precursor”), allowing said solution to gel (usually resulting in a gel or swollen polymer network, generically an “aerogel precursor”), optionally performing solution-phase processing (e.g., aging, chemical treatment, hydrophobic treatment, crosslinking), optionally purifying the solvent retained in the pore structure of the aerogel precursor (e.g., via diffusive soaking or “solvent exchange”), and then drying via ambient-pressure evaporative drying, freeze drying, or preferably supercritically drying (e.g., from carbon dioxide or organic solvent).

A gel, as described herein, is essentially a colloidal system in which a network of interconnected nanoscale structures spans the volume of a liquid medium. An aerogel is essentially the in-tact solid component of a gel isolated from its liquid component. When the liquid in a gel is evaporated, capillary stresses may arise as the liquid-vapor interface proceeds into the interior of the gel network. For many gel materials, these capillary stresses will cause the gel network to consolidate and collapse in on itself. If functional groups lining the backbone of the gel network possess the propensity to stick to each other (such as hydroxyl groups, which can engage in hydrogen bonding with one another), this shrinkage may be generally irreversible. By heating the pore fluid in the gel past its critical point (past which point the fluid has no surface tension), however, the liquid component of the gel may be removed as a supercritical fluid via isothermal depressurization leaving behind the solid component of the gel isolated from its liquid component essentially intact.

Alternative drying strategies may also be employed. For example, if the gel backbone has a suitably high modulus, the material may be dried through evaporation without collapsing, providing an aerogel. Non-high-modulus gels may be dried through evaporation by first replacing the functional groups on a gel backbone with sterically-hindered non-polar groups. Although evaporative drying may still result in collapse of the gel network's porosity, this collapse can be reversed as the struts of the gel backbone cannot stick to themselves.

Evaporatively drying with a low-surface-tension solvent may further reduce loss of porosity in evaporative drying of aerogel precursors. Similarly freeze drying may be used, as the transition of solid to vapor through sublimation does not impart capillary stress on the gel's backbone. Aerogel materials may exhibit a variety of different compositional morphologies.

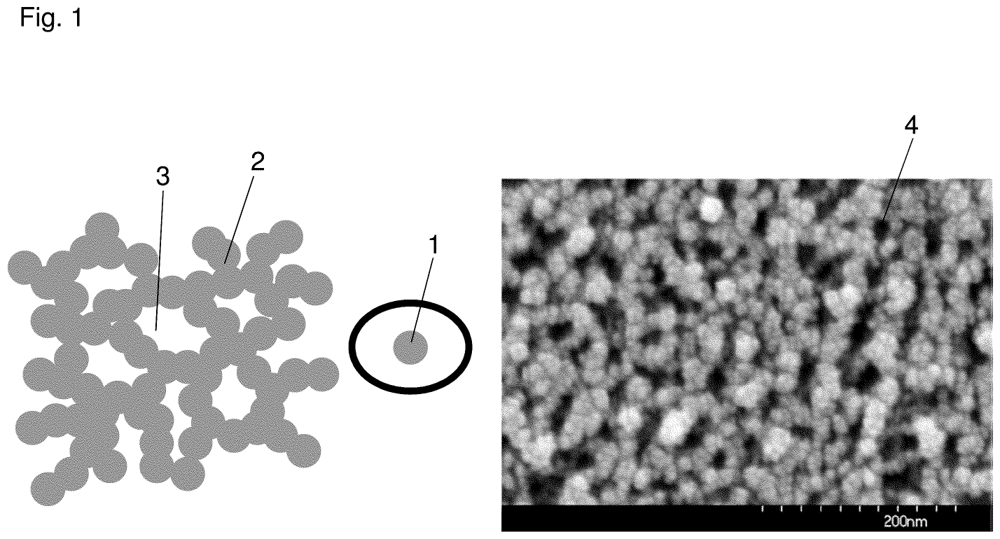

FIGS. 1-5 depict a number of different morphologies of aerogel materials as they may be observed by scanning electron microscopy.

FIG. 1 shows a “string-of-pearls” morphology typical of silica and many other metal and metalloid oxide gels and aerogels, in which microporous or non-porous spheroidal elements such as 1 interconnect to form a percolating network 2 carving out mesopores and/or macropores such as 3 as seen by scanning electron microscopy in 4.

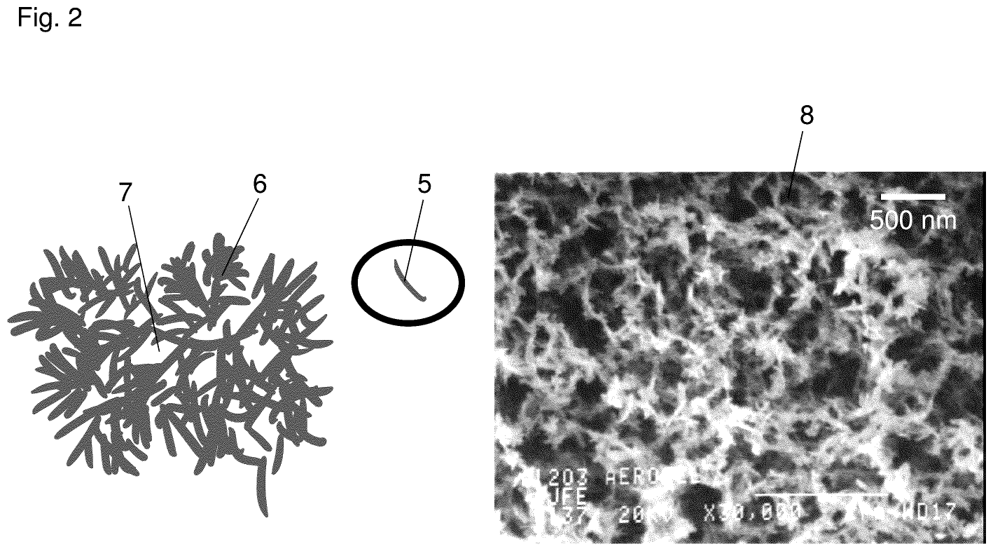

FIG. 2 shows a “leaf-like” or acicular morphology typical of alumina and acid-catalyzed silica gels and aerogels, in which elongated needle-like elements such as 5 are assembled into leaf-like structures that form a percolating network 6 carving out mesopores and/or macropores such as 7 as seen by scanning electron microscopy in 8.

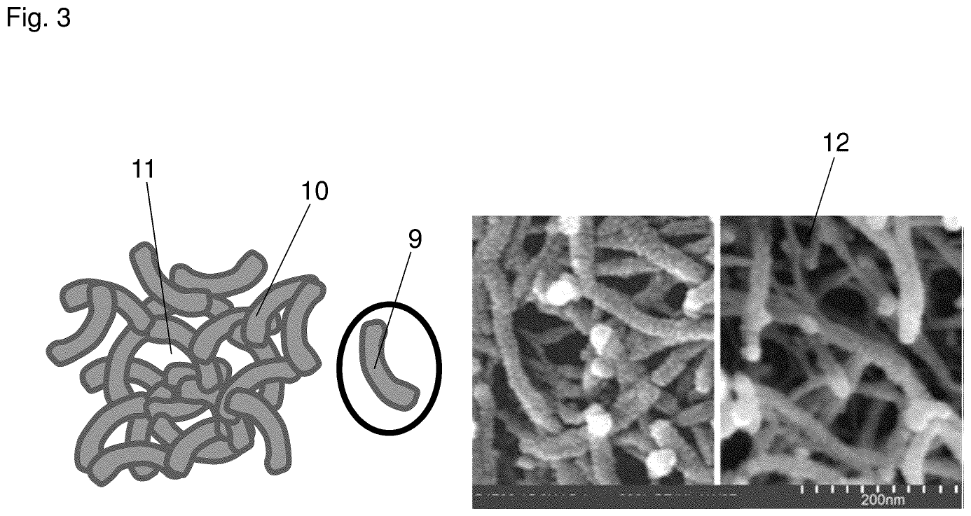

FIG. 3 shows a “worm-like” morphology typical of vanadia and some polymer gels and aerogels, in which tubular or elongated worm-like elements such as 9 interconnect to form a percolating network 10 carving out mesopores and/or macropores such as 11 as seen by scanning electron microscopy in 12.

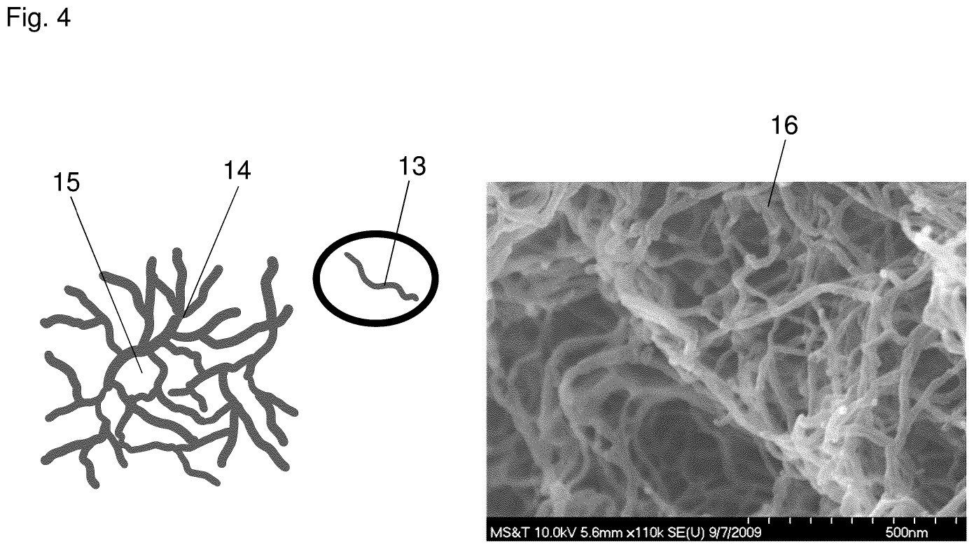

FIG. 4 shows a fibrous morphology typical of some polymer gels and aerogels (such as those based on polyurea) and carbon nanotubes, in which high-aspect-ratio fibers such as 13 interconnect to form a percolating network 14 carving out mesopores and/or macropores such as 15 as seen by scanning electron microscopy in 16.

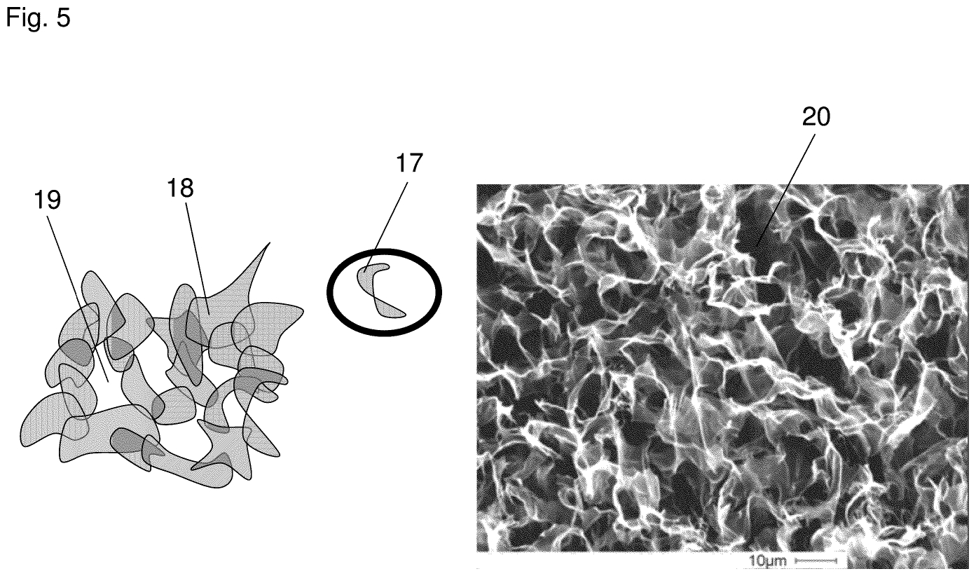

FIG. 5 shows a “sheet-like” morphology typical of graphene, molybdenum disulfide, and boron nitride gels and aerogels in which sheet-like or platelette domains such as 17 interconnect to form a percolating network 18 carving out mesopores and/or macropores such as 19 as seen by scanning electron microscopy in 20.

As discussed herein, layered aerogel composites may be produced by combining fibrous sheets, plies comprising multiple fibrous sheets laminated together, monolithic aerogel materials, rigid plastics, rigid ceramics, and/or materials to aid in joining of these layers. As described herein, multilayer plies may comprise multiple sheets bonded together, where the sheets may include oriented or unoriented fibers of various compositions and dimensions, a matrix, other materials.

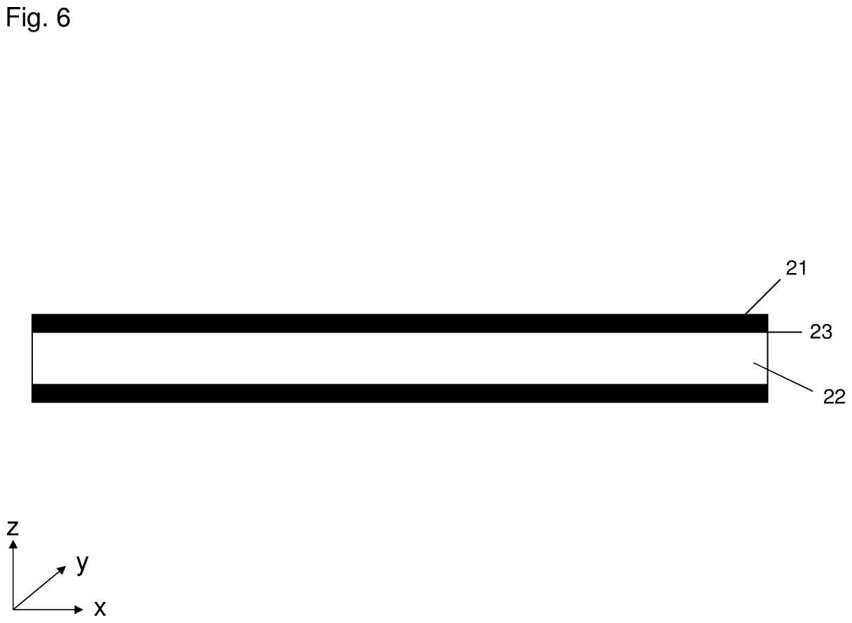

FIG. 6 shows one general configuration for such composites comprising a fibrous sheet, multilayer ply, rigid plastic, or rigid ceramic 21, an aerogel material 22, and optional adhesion or joining layer in between 23.

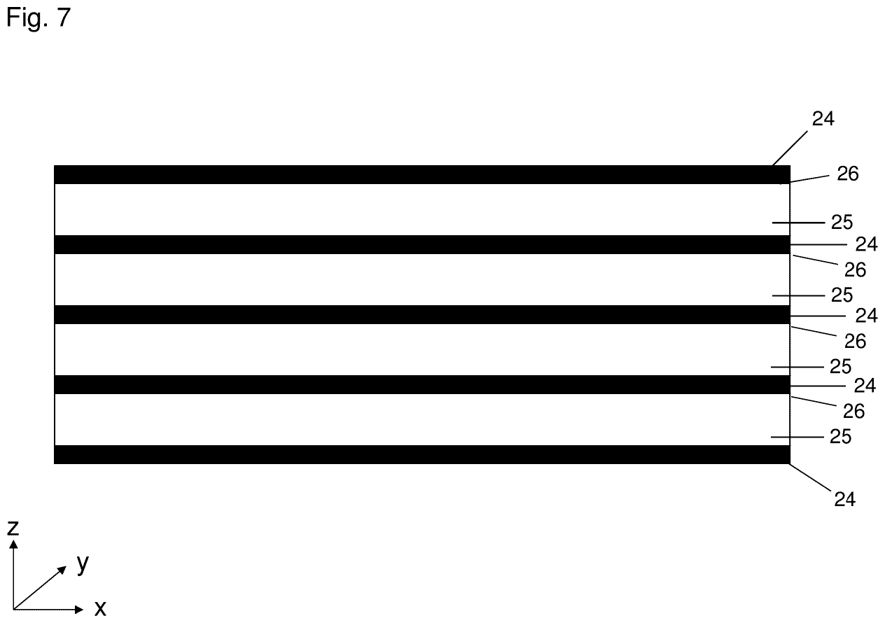

FIG. 7 shows schematically how multiple layers of one or more fibrous sheets, multilayer plies, plastic sheets, rigid plastic plates, or rigid ceramics 24 can be layered with monolithic aerogel materials 25 with optional adhesion or joining layers in between 26.

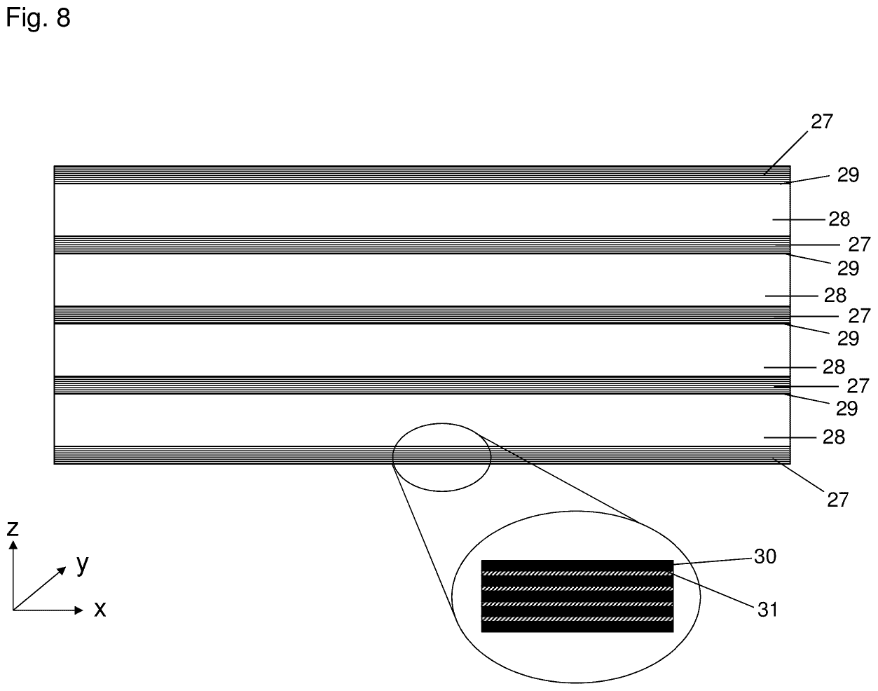

FIG. 8 shows additional detail of how a multilayer aerogel composite comprising multilayer plies 27 and aerogel materials 28 with optional adhesion or joining layers 29 can be arranged, wherein the multilayer ply internally comprises multiple layers of sheets 30 and matrix 31 holding said layers together. The sheets 30 may include oriented fibers, unoriented fibers, woven fibers, or a continuous material.

Various strategies may be employed to facilitate manufacturing of layered aerogel composites including, for example, embedding of sheets into aerogel material precursors; joining of dry aerogel materials to fibrous sheets; introduction of diffusion holes into fibrous sheets; preorientation of fibrous sheets followed by infiltration with aerogel material precursor; introduction of adhesives; introduction of an array of nanoscale structures between layers; chemical functionalization of the fibrous sheets; chemical functionalization of the aerogel materials; inclusion of specific chemical functional groups in the backbone of the aerogel material; inclusion of a removable shaping template in the aerogel material; mechanical or laser-assisted removal of material from the aerogel material; introduction of a reticulated array of voids into the aerogel material; and thermochemical processing of the composite to change the composition and/or morphology of materials in the composite, amongst others.

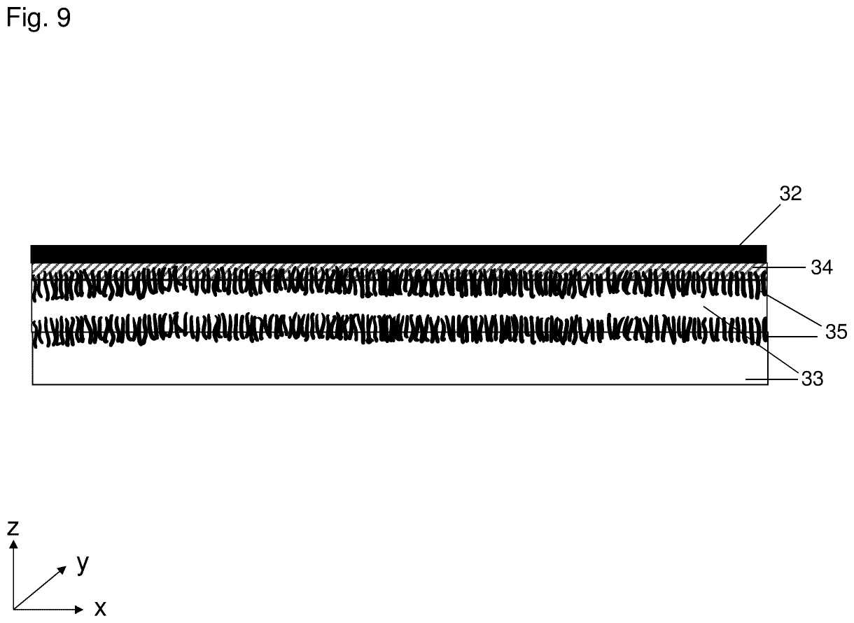

FIG. 9 schematically depicts one example of how these various strategies could be combined to form a layered aerogel or composite comprising a fibrous sheet, multilayer ply, or plate 32 to a strong monolithic aerogel or gel 33, bonded by an adhesive layer or other interphase layer 34 and reinforced by an array of substantially oriented nanostructures 35, in which two aerogel or gel layers are joined by, or the interface of two aerogel or gel layers are reinforced by, an array of substantially oriented nanostructures, such as carbon nanotubes or boron nitride nanotubes, that spans the interface of the two aerogel or gel layers. Other strategies may be employed as well.

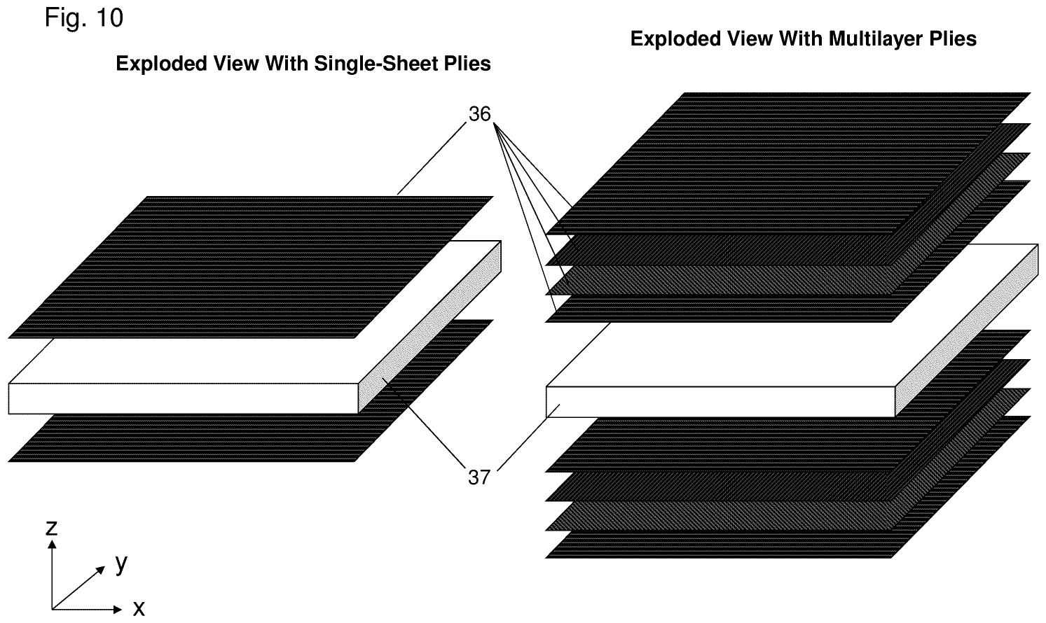

In one set of embodiments, the layered aerogel composite comprises alternating layers of oriented fiber sheets and monolithic mechanically strong aerogel materials. FIG. 10 shows how sheets of oriented fibers 36 may be arranged with aerogel or gel materials 37 to produce a layered aerogel composite with single-sheet plies (exploded view, left) or multisheet plies (exploded view, right). Suitable fibers may include high-strength and high-modulus carbon fibers; polymer fibers such as poly(p-phenylene-2,6-benzobisoxazole)) (e.g., Zylon®), poly(paraphenylene terephthalamide) fibers (e.g., Kevlar®), ultrahigh molecular weight polyethylene fibers (e.g., Spectra® or Dyneema®), poly(hydroquinone diimidazopyridine) fibers (e.g., M5), polyamide fibers (e.g., Nylon®), poly(acrylonitrile) fibers (PAN), and oxidized poly(acrylonitrile) fibers (O-PAN); biologically-derived or -inspired fibers such as cellulosic fibers (e.g., natural cellulose, synthetic cellulose) and silk; viscose fibers (such as Rayon®); ceramic fibers comprising alumina, silica, glass, zirconia, yttria-stabilized zirconia, hafnia, boron, metal/metalloid carbides (e.g., silicon carbide), and metal/metalloid nitrides (e.g., boron nitride); carbon-nanotube and carbon-nanofiber fibers and sheets; and boron-nitride-nanotube fibers and sheets.

In some embodiments, carbon nanotubes or carbon nanofibers with a length greater than about 50 μm, 100 μm, greater than about 500 μm, greater than about 1 mm may be used.

In some embodiments, single-wall, double-wall, or multiwall carbon nanotubes may be used.

In further embodiments, carbon nanotubes with a diameter of about 1 nm, greater than about 1 nm, greater than about 2 nm, greater than about 5 nm, greater than about 10 nm, greater than about 20 nm may be used.

In some embodiments, the sheets and multilayer plies of sheets containing unoriented fibers may be used.

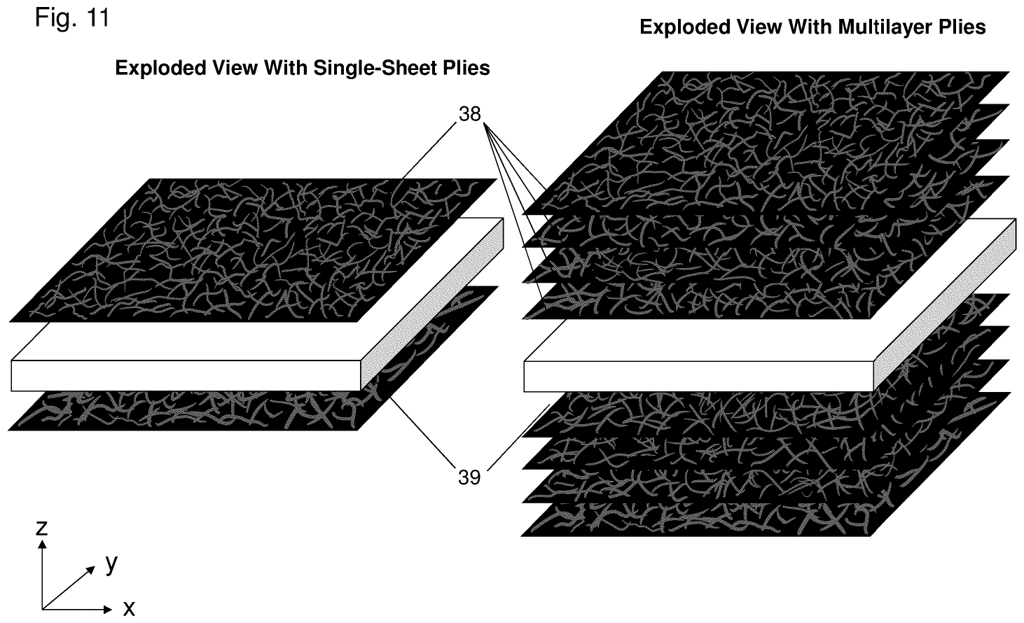

FIG. 11 shows how sheets of unoriented fibers 38 may be arranged with aerogel materials 39 to form layered aerogel composites with single-sheet plies (exploded view, left) and multisheet plies (exploded view, right). Layers containing fibers and sheets may include a resin or matrix material to bind fibers and/or sheets together.

Suitable resins may include thermosets such as epoxies and phenolics, thermoplastics such as polyetheretherketone, chemosets such as caprolactam, and other resins. Suitable matrix materials include carbon, silicon carbide and other carbides, metals, and other matrix materials. Suitable mechanically strong aerogel materials include aerogels comprising: x-aerogels such as polymer-crosslinked silica, polymer-crosslinked vanadia, and other polymer-crosslinked metal oxides and metalloid oxides; organic polymers such as polyurea, polyurethane, polyimide, polybenzoxazine, polyamide, poly(cyclopentadiene), acid-catalyzed resorcinol-formaldehyde, cellulose, and other organic aerogels; carbides such as silicon carbide and boron carbide; metal or metalloids such as iron, nickel, copper, tin, titanium, silicon, and boron; metal chalcogenides such as cadmium sulfide, cadmium selenide, silver selenide, palladium sulfide, and others; and allotropes of carbon, including amorphous carbon, graphitic carbon, glassy carbon, carbon nanotubes, diamond, activated carbon, and graphene.

In some embodiments, aerogel materials may incorporate (3-aminopropyl)triethoxysilane or other aminoalkylalkoxysilanes. In some preferred embodiments, polymer-crosslinked aerogels may be crosslinked with an inorganic polymer, such as a silicone.

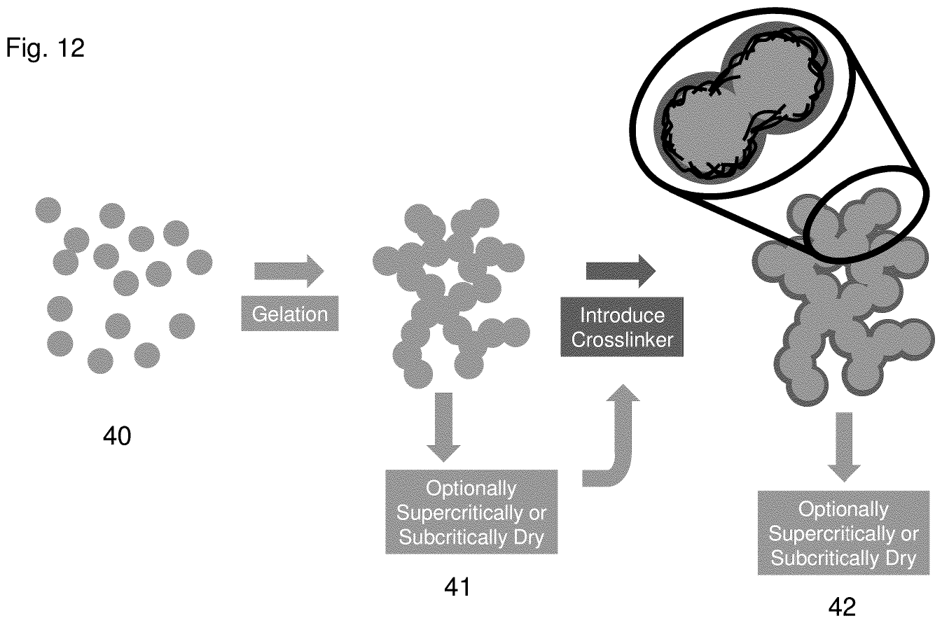

FIG. 12 schematically depicts the formation of polymer-crosslinked gel material which can be dried to form a polymer-crosslinked aerogel material: a dispersion of nanoparticles (e.g., a sol, 40) interconnects to form a particle network (e.g., a gel, 41), after which a crosslinker forms a generally conformal surface layer of crosslinker or crosslinked product (e.g., a polymer) bonded to the surfaces of the particle network (e.g., a polymer-crosslinked gel, 42). The crosslinked gel 42 may then be supercritically or subcritically dried to afford a polymer-crosslinked aerogel (also called an x-aerogel).

Layered aerogel composites may be well-suited for ballistics applications such as bullet-proof vests and armored vehicle cladding. For such applications, it may be desirable that the aerogel material exhibit a high specific energy absorption, defined as the integral of the material's compressive stress vs. strain curve, for example, greater than about 80 J/g, greater than about 100 J/g, greater than about 150 J/g. greater than about 200 J/g. Additionally, it may be desirable that the oriented fibers have high tensile strength, for example, greater than about 200 MPa/unit specific gravity (SG), greater than about 1 GPa/SG, greater than about 2 GPa/SG, greater than about 3 GPa/SG, greater than about 4 GPa/SG, greater than about 5 GPa/SG, greater than about 7 GPa/SG, greater than about 10 GPa/SG.

Aerogels with fibrous (FIG. 4) or worm-like morphology (FIG. 3) may be particularly well-suited for such applications. Examples of aerogels with fibrous morphologies include polyurea aerogels. Examples of aerogels with worm-like morphologies include vanadia aerogels. Hierarchically porous aerogels, i.e., aerogels exhibiting a high degree of microporosity and mesoporosity (and possibly also macroporosity), are also well-suited.

In these composite configurations, a synergistic effect between the oriented fiber layers and aerogel layers may arise. Without wishing to be bound to a particular theory. such a synergistic effect may be appreciated by imagining the following sequence of phenomena. Momentum from a ballistic object incident on the composite may first be slowed by oriented fibers. Next, that momentum may be efficiently distributed over an aerogel layer, which exhibits high internal surface area. The aerogel material then compresses in response, during which its interior struts deform and/or break thereby absorbing momentum through bond breaking, strain, pore collapse, phase changes, and/or heat dissipation. The ballistic object, now with reduced momentum, proceeds into another fiber-containing layer and the process repeats. Depending on the momentum and geometry of the ballistic object, the object may be slowed to a halt over a relatively short distance of alternating fiber-containing and aerogel layers, for example, a few centimeters.

A layered aerogel composite suitable for ballistics applications may comprise sheets or multisheet plies of carbon nanotubes or carbon-nanotube fibers layered with polymer-crosslinked vanadia aerogel. Alternatively, the composite may comprise layered sheets or multisheet plies of ultrahigh-molecular-weight-polyethylene fiber and polymer-crosslinked vanadia aerogel. Aramid fibers are also particularly well-suited. Further alternatively, polyurea aerogel, polyurethane aerogel, polybisoxazine aerogel, or surfactant-templated polymer-crosslinked silica aerogel may be used. In some embodiments, multisheet plies comprising oriented fiber sheets in which the orientation of the fibers is rotated from sheet to sheet may be included. These multisheet plies may comprise more than one, more than ten, more than hundred sheets. Sheets in multisheet plies may be laminated together with a matrix material such as an epoxy, a polyurethane, a phenolic, a polyether etherketone, a silicone, a polyureasilazane, a polybutadiene, or other suitable matrix material.

Layered aerogel composites may be well-suited for structural applications. For many structural applications, such as aerospace structures, it is highly desirable to maximize the stiffness of a structure while simultaneously minimizing the structure's weight. Examples include beams and wings. Layered aerogel composites configured into a sandwich structure may be well-suited for such applications and may be lighter than similar sandwich structures employing traditional engineering foams such as expanded polystyrene. This may be achieved through introduction of a reticulated pattern of macroscopic (>1 μm) voids into the aerogel material.

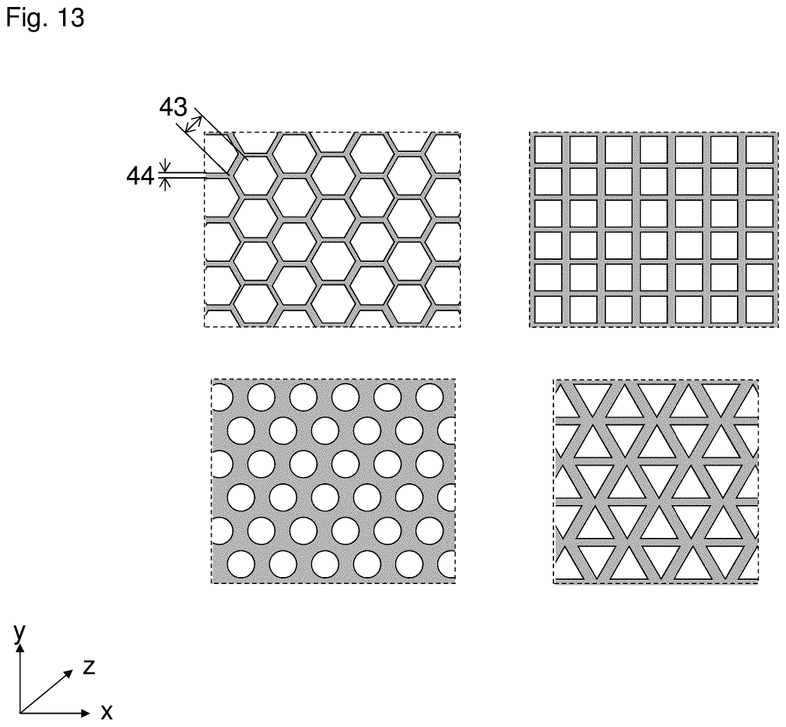

FIG. 13 depicts examples of reticulated patterns of interest. For example, a sandwich configuration comprising a sheet or multisheet ply, then an aerogel layer, then another sheet or multisheet ply may be produced, providing a sandwich structure. In such a configuration, the aerogel material may serve as a shear-bearing component of the structure, while the plies on the edges of the composite may serve to bear axial loads. Suitable monolithic aerogel materials include aerogels with high specific stiffness and/or high specific strength. Although aerogels are typically thought of as ultralight materials, aerogel materials with high specific stiffness and/or strength often exhibit densities ranging from 0.1 to 0.9 g/cm³ and may be denser than engineering foams typically used in sandwich structures.

As discussed herein, however, aerogels with macroscopic reticulated voids, such as an aerogel with a honeycomb-like structure, may be prepared. Suitable aerogels are mechanically robust. Polymer-crosslinked silica and other polymer-crosslinked oxide aerogels with densities greater than about 0.1 g/cm³ are particularly suited, as are polyurea, polyurethane, polyimide, polyamide, polybisoxazine, polycyclopentadiene, and acid-catalyzed resorcinol-formaldehyde aerogels with densities greater than about 0.1 g/cm³. Voids may then be introduced into these aerogels through one or more methods including: molding; thermal removal, dissolution, or chemical removal of a shaping template; mechanical removal with a tool such as a mill, drill, vibrating needle, waterjet, stamp, rolling cutter, rolling stamp, or lathe; laser.

In some embodiments, polymer spheres (e.g., poly(methyl methacrylate), polystyrene) are included in the aerogel precursor and can be later dissolved away with organic solvents (e.g., acetone) or burned, decomposed, or volatilized off. In yet another set of embodiments, voids may be introduced by casting the aerogel precursor into a suitable shaped mold wherein the aerogel precursor formulation is tailored to limit dimensional changes upon gelation.

In some embodiments, precursors for organic aerogels prepared using a low concentration of solids (e.g., as less than about 10% w/w or less than about 5% w/w) may be used to limit shrinking and/or cracking of the aerogel precursor. In some embodiments, polymer-crosslinked aerogel precursors in which a surface layer of crosslinker or crosslinked product forms over the conformal skeletal surfaces of the gel network are prepared without causing greater than about 2% shrinkage, greater than about 5% shrinkage, greater than about 7.5% shrinkage, greater than about 10% shrinkage, greater than about 20% shrinkage, greater than about 30% shrinkage, greater than about 50% shrinkage, for example, by limiting the amount of crosslinking agent added onto the gel network.

In further embodiments, the resulting polymer-crosslinked aerogel has a density less than about 0.5 g/cm³, less than about 0.4 g/cm³, less than about 0.3 g/cm³, less than about 0.2 g/cm³, less than about 0.15 g/cm³, less than about 0.1 g/cm³. Voids may be columnar with cross sections including a circle, oval, square, rectangle, hexagon, or other shape. Voids may also be non-columnar, for example, spherical. Non-columnar voids may be introduced through removal of a shaping template. Depending on the cross-sectional geometry and dimension of the reticulated voids and void walls, the resulting reticulated aerogel material (which itself has solid mesoporous walls) may exhibit a substantially reduced enveloped density while still providing suitable compressive stiffness and shear strength for use in a structural sandwich panel. For example, in one embodiment, a honeycomb structure made of an aromatic polyurethane aerogel made by reacting tris(isocyanatophenyl)methane (e.g., Desmodur® RE) and 1,3,5-trihydroxybenzene combined in a 1:1 ratio with bulk density of 0.760 g/cm³ with hexagonal columnar voids in which the hexagonal unit cell has a 1-cm edge-length 43 and 0.1-cm wall-thickness 44 would exhibit an envelope density of only 0.274 g/cm³, yet could still provide a honeycomb-level compressive modulus of about 270 MPa and compressive strength of about 122 MPa. The envelope density may be further lowered by adjusting the cross section and dimensions of the reticulated voids.

In another embodiment, the same aromatic polyurethane aerogel material with 3-cm edge-length 43 hexagonal columnar voids and 0.08-cm wall-thickness 44 may provide a honeycomb with an envelope density of only 0.08 g/cm³ yet a honeycomb-level compressive modulus of 78 MPa and compressive strength of 35 MPa. This compares favorably to other high-strength low-density engineering materials such as polyethylene terephthalate planks (e.g., ArmaFORM PET planks), which would only exhibit a compressive modulus of 30 MPa and a compressive strength of 1 MPa at comparable envelope densities.

Such reticulated aerogel materials may then be included in a layered aerogel composite to produce a lightweight sandwich structure. Particularly suitable fiber layers include graphite/epoxy and fiberglass/polyurethane sheets or multisheet plies. In addition to aerospace and general structural engineering applications, layered aerogel structures comprising reticulated aerogel materials may find use in lightweight surfboards, wakeboards, paddleboards, skis, snowboards, skateboards, kayaks, canoes, boats, and other high-performance sports equipment; automotive and trucking applications including body panels, impact panels, seat structures, suspension, and refrigerated cavities; ground-based and airborne wind turbine applications including turbine blades and housing structures; and other structural applications.

Layered aerogel composites may be useful for multilayer insulation (MLI). In a multilayer insulation configuration, successive radiating layers are placed in series and thermally separated. Heat incident on the first radiating layer will partially radiate forward into the MLI. That heat flux may then be only partially radiated further to the next radiating layer in the MLI, and may further decrease with each successive layer.

A layered aerogel composite suitable for MLI may comprise alternating layers of infrared-opaque fibers, such as carbon fibers, and aerogel materials. Mechanically robust aerogel materials are particularly well-suited, for example, polymer-crosslinked aerogels and organic aerogels.

In some embodiments, the aerogel material is a flexible monolithic aerogel such as a polyisocyanate, polyurea, polyurethane, polyimide, polysiloxane, cellulose, nanotube-based, or graphene-based aerogel. In further embodiments, the flexible monolithic aerogel is silica-based. In further embodiments, a polyurethane aerogel comprising tris(isocyanatophenyl)methane, 4,4′-sulfonyldiphenol, and/or 1,1,1-tris(4-hydroxy phenyl)ethane may be used. In some embodiments, the aerogel material may have a Young's modulus of less than about 20 MPa. In some embodiments, the aerogel material may exhibit a speed of sound of less than about 200 m/s. In still further embodiments, the monolithic aerogel comprises silsesquioxane. In another set of embodiments, the monolithic aerogel is a hybrid between an organic polymer and an inorganic material, for example, a polyimide and silsequioxane.

Such layered aerogel composites may be flexible, and thus suitable for a wide variety of applications including: radiation shielding for aerospace vehicles, satellites, and other spacecraft; insulation in clothing, boots, gloves, and other apparel; insulation for cold chain logistics such as refrigeration systems, refrigerated trucks, insulating boxes, insulated shipping containers, and pharmaceuticals insulation; cryogenic applications such as liquefied gas, cryogenic tanks, and dewars; and architectural applications such as insulation for walls, fabric roofing, and floors.

Layered aerogel composites may be suitable for aerospace reentry shielding, torch and flame shielding, and ablative applications. Suitable composites may comprise ablative layers, carbonizable or carburizable layers, aerogel material layers, fiber-reinforced aerogel material layers, oxidation-resistant fibers, and other fibers. For example, a well-suited layered aerogel composite may comprise a carbon-fiber-reinforced phenolic multisheet ply. In some embodiments, the layered aerogel composite may comprise polymer-crosslinked metal or metalloid oxide aerogels. In further embodiments, the polymer-crosslinked metal or metalloid oxide aerogel comprises a substantially aromatic polymer and can be transformed into a metal, metalloid, or carbide aerogel material upon exposure to heat.

Well-suited layered aerogel composites may also comprise a monolithic aerogel material that is internally reinforced with fibers. Examples of suitable aerogel matrix materials include carbon, silica, alumina, titania, yttria, zirconia, and hafnia. Other aerogel matrix materials may be suitable. Examples of suitable fiber reinforcements include vitreous glass fiber, alumina fiber, single-crystal alumina fiber, zirconia fiber, yttrium-stabilized zirconia fiber, hafnia fiber, silicon carbide fiber, boron fiber, carbon fiber, oxidized poly(acrylonitrile) fiber. In some embodiments, the fiber reinforcement may take the form of discrete fibers. In other embodiments, the fiber reinforcement may take the form of a felt. In still further embodiments, the fiber reinforcement may take the form of a woven sheet. Other examples of well-suited layered aerogel composites may comprise a hafnia or zirconia aerogel material reinforced with yttrium-stabilized zirconia or hafnia felt.

In some embodiments, the aerogel material comprises substance with melting points greater than about 2500° C. In some embodiments, an oxidized-poly(acrylonitrile)-crosslinked oxide aerogel may be included, which may serve as a carburizable ablative material. In some embodiments, a layer of polyetheretherketone plastic may be included as an ablative layer. In further embodiments, a plate of silicon carbide, oxide-based ceramic, or other ceramic may be included.

In even further embodiments, an aerogel layer absorbs energy through one or more of the following mechanisms: melting; undergoing phase change; oxidizing; carbonizing; pyrolyzing; carburizing; reducing; vaporizing; subliming; disintegrating; compacting. In some embodiments, a porous material remains after the aerogel layer has undergone exposure to heat and/or oxidation. In some embodiments, the layered aerogel composite absorbs impact from abrasive or corrosive materials such as nano- and/or microparticles (including oxide and metal particles) or metal vapor. Layered aerogel composites could be used to protect spacecraft from the heat of entry into a planetary atmosphere, to shield against high-temperature flames, and to shield against energetic materials such as thermites and explosives.

Layered aerogel composites may also be used for storing electrical and electrochemical energy. For example, alternating layers of electrically conductive fibers and electrically insulating aerogel materials can stacked and bonded and the resulting composite may be suitable as multilayer parallel-plate capacitor. In some embodiments, suitable aerogel materials may include organic polymer aerogels, metal or metalloid oxide aerogels, or other aerogel materials.

Other suitable layered aerogel composites may comprise alternating layers of electrically insulating fibers or sheets and electrically conductive aerogel layers. In some embodiments, suitable aerogel materials may comprise carbon, carbon nanotubes, carbon nanofibers, graphene, diamond, metals or metalloids, metal or metalloid carbides. In some embodiments, the thickness of the aerogel material is less than about 10 nm, less than about 100 nm, less than about 1 μm, less than about 100 μm, less than about 1 mm.

In some embodiments, electrically conductive layers may comprise carbon nanotubes, carbon nanofibers, carbon fibers. Some layered aerogel composites may be capable of serving as both a capacitor and a structural member. Some such layered aerogel composites may be flexible. In some embodiments, the aerogel material is a polymer-crosslinked aerogel. In further embodiments, the aerogel material is electrochemically active and may store energy electrochemically. In some configurations, faradic pseudocapacitance may be observed. In some configurations, electrically conductive layers are wired together to serve as a single electrode. In some embodiments, the electrically insulating layers comprise polystyrene, for example, polystyrene fibers, a polystyrene layer, polystyrene-crosslinked aerogel, polystyrene aerogel. In some embodiments, an aerogel material comprising manganese oxide may be included. In some embodiments, electroless deposition may be used to form a substantially conformal coating of a metal over the interior skeletal surfaces of the aerogel or gel backbone or surfaces of the fiber-containing sheet or multisheet ply.

In some embodiments, chemical vapor deposition or atomic layer deposition may be used to form a substantially conformal coating of a metal or other material over the interior skeletal surfaces of the aerogel or gel backbone or surfaces of the fiber-containing sheet or multisheet ply. In some preferred embodiments, oxidative chemical vapor deposition (oCVD) or initiated chemical vapor deposition (iCVD) may be used to form a substantially conformal coating of a polymer or other insulating material over the interior contour surfaces of the aerogel material. In preferred embodiments, such metal or polymer coatings are substantially pin-hole free and serve as a coherent percolating network.

Aerogel materials with conformal metal or polymer coatings over their interior skeletal surfaces may be useful outside of a layered configuration as electrical and electrochemical storage materials themselves. For example, an aerogel material comprising a carbon material (e.g., amorphous carbon, graphitic carbon, glassy carbon, carbon nanotubes, carbon nanofibers, diamond, graphene, pyrolyzed acid-catalyzed resorcinol-formaldehyde, activated carbon, activated carbon aerogel) or comprising a metal or metalloid material (e.g., iron, nickel, tin, silicon, or other metal or metalloid) internally coated with a substantially conformal pinhole-free insulating layer (e.g., polystyrene, polymethylmethacrylate), further internally coated with a second, substantially pinhole-free conductive layer (e.g., a metal; a carbon material; a conductive polymer such as poly(3,4-ethylenedioxythiophene) (PEDOT), polythiophene, poly(3,4-ethylenedioxythiophene) poly(styrenesulfonate) (PEDOT:PSS), a polyacetylene, a polyphenylene vinylene, a polypyrrole, a polyaniline, a polyphenylene sulfide) could serve as a solid-state supercapacitor. Successive conformal coatings may be included as well. Such core-shell aerogel nanocomposites may simultaneously serve as a dual structure and solid-state capacitor or battery simultaneously and have an energy density of 1 W/kg, 10 W/kg, 100 W/kg, 1 kW/kg, 2 kW/kg. 5 kW/kg, or higher.

Layered aerogel composites comprising laminated aerogel materials without fiber-containing layers may also be prepared. Since the manufacturing of strong aerogel materials often relies on diffusion-limited steps including solvent exchange, optional infiltration of crosslinking agent and subsequent removal of unused crosslinking agent and/or byproducts, and drying (either subcritically or supercritically), production of large volumetric solids in which no dimension is less than about 2.5 cm can be extremely costly, time consuming, and challenging (e.g., thick plates, rectangular solids, spheres, etc.).

The inventor has appreciated that it is possible laminate plates of strong aerogel materials together to form large volumetric solids that are otherwise difficult to obtain. Such composites may be suitable for use as machinable blanks. In some embodiments, a polymer-crosslinked metal or metalloid oxide aerogel is prepared in a sheet or plate form.

In some embodiments, an organic polymer aerogel is prepared in sheet or plate form. In the preferred embodiments, the sheet or plate is less than about 5 cm in thickness. The sheet or plate is then joined to another aerogel sheet or plate with an adhesive. Examples of well-suited adhesives include cyanoacrylates, epoxies, silicones, and organic glues.

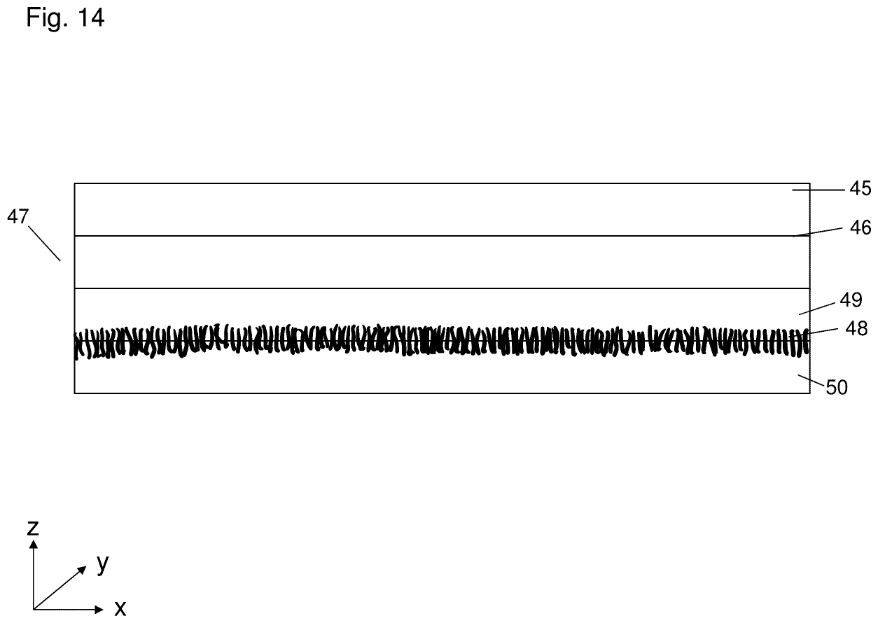

FIG. 14 depicts schematically how sheets or plates of an aerogel (or gel) material 45 may be arranged and joined by an interface 46 to produce a larger form 47. In some preferred embodiments, the aerogel materials have a compressive yield strength greater than about 1 MPa, greater than about 5 MPa, greater than about 10 MPa. In some preferred embodiments, the aerogel materials have a compressive modulus greater than about 1 MPa, greater than about 10 MPa, greater than about 100 MPa, greater than about 500 MPa, greater than about 1 GPa.

In some preferred embodiments, the bulk density of the aerogel material is greater than about 0.1 g/cm³, greater than about 0.2 g/cm³, greater than about 0.3 g/cm³, greater than about 0.45 g/cm³, greater than about 0.6 g/cm³, greater than about 0.75 g/cm³, greater than about 0.9 g/cm³.

In some embodiments, the aerogel material is a polymer-crosslinked silica aerogel, such as a polyisocyanate-crosslinked silica aerogel, epoxide-crosslinked silica aerogel, polystyrene-crosslinked silica aerogel, poly(acrylonitrile)-crosslinked silica aerogel, or other crosslinked aerogel. In some embodiments, the aerogel material comprises an organic aerogel material such as polyisocyanate, polyurea, polyurethane, polyamide, polybisoxazine, polycyclopentadiene, or acid-catalyzed resorcinol-formaldehyde. In some preferred embodiments, the aerogel material comprises at least in part a polymer material.

In some embodiments, the aerogel material may incorporate reactive functional groups into its backbone or polymer surface layer such as hydroxyl, amine, aminoalkyl, acyl chloride, oxirane, isocyanate, carboxylic acid, or other reactive functional group. In preferred embodiments, lamination of layers of strong aerogel materials is facilitated by dangling reactive side groups lining the struts of the aerogel material backbones which permit chemical bonding to an adhesive, or to other aerogel layers directly. In some of these embodiments, these reactive side groups comprise isocyanate, amine, biuret, uretdione, isocyanurate, urethane, urea, amide, acyl urea, imide, oxazolidone, oxadiazinetrione, oxirane, acyl halide, carboxylic acid, and/or hydroxyl.

In some embodiments, a crosslinking agent may be used to join aerogel sheets or plates to each other. In some embodiments, an adhesive may be used. In other embodiments, functional groups in one aerogel material may be invoked through heat, light, pressure, ultrasonic waves, mechanical force, or other means to react directly with functional groups in another aerogel material, resulting in a bond. In some embodiments, an array of nanostructured elements is embedded in an aerogel sheet or plate such that a portion of the array is exposed on the surface of the aerogel material. Said array aids in forming a nanoreinforced adhesive joint with another aerogel material or fiber-containing layer.

Capillary-driven wetting by the array of nanostructured elements assists in wicking adhesive or other liquid-phase materials into the array, facilitating an improved bond. In some embodiments, a layer containing carbon fibers such as a carbon-fiber prepreg layer may be bonded to an aerogel material. In some preferred embodiments, an array of nanostructured elements aids in joining other materials to the aerogel material.

FIG. 14 depicts how an array of oriented nanostructures 48 may be used to join aerogel or gel materials 49 and 50 together. Examples of well-suited nanostructured elements include carbon nanotubes (e.g., an array of vertically-aligned carbon nanotubes), carbon nanofibers, boron nitride nanotubes, oxide nanofibers, and other nanofibers. In some embodiments, the diameter of the nanostructured elements is greater than about 1 nm, greater than about 5 nm, greater than about 10 nm, greater than about 20 nm, greater than about 50 nm, greater than about 100 nm, greater than about 500 nm.

In some instances, it may be advantageous to join aerogel layers together by joining wet aerogel precursor materials (i.e., gels) together prior to subcritical or supercritical drying. In some embodiments, a crosslinking agent may be used to join aerogel precursor layers or plates to each other. In other embodiments, functional groups in one aerogel precursor material may be invoked through heat, light, pressure, mechanical force, or other means to react directly with functional groups in another aerogel material, resulting in a bond. In some embodiments, an array of nanostructured elements is embedded in an aerogel precursor sheet or plate such that a portion of the array is exposed on the surface of the aerogel precursor material, and another aerogel precursor material is cast onto the exposed portion of the array.

In some layered aerogel composites, the inventor has found advantages in preparing nanocomposites of arrays of oriented nanostructured elements and aerogel materials for serving as aerogel material layers. For example, a liquid-phase aerogel precursor (e.g., a sol, a reactive monomer mixture, or another liquid-phase precursor) is added to an array of vertically-aligned carbon nanotubes, forming a gel reinforced by the vertically-aligned carbon nanotubes. In some embodiments the gel may be subcritically or supercritically dried (e.g., from supercritical carbon dioxide) to form an aerogel material reinforced by vertically-aligned carbon nanotubes.

In some embodiments, the aerogel material comprises a metal oxide or metalloid oxide aerogel. In some embodiments, the aerogel material is a polymer-crosslinked aerogel such as an x-aerogel. In some embodiments, the aerogel material comprises an organic aerogel. In some embodiments, the aerogel material comprises a carbon material, for example, amorphous carbon, graphitic carbon, glassy carbon, carbon nanotubes, carbon nanofibers, diamond, graphene, activated carbon. In some embodiments, the aerogel material comprises a metal, metalloid, or carbide aerogel. In some embodiments, boron nitride nanotubes may serve as the nanostructured elements.

Other nanostructured elements such as oxide and polymer nanofibers (e.g., silica nanofibers, alumina nanofibers, polyaniline nanofibers) and other types and shapes of nanoparticles are suitable as well. The resulting oriented-nanostructure-array-reinforced nanocomposite is useful as its own material outside of a layered composite configuration and also provides multifunctional advantages such as improved electrical and thermal conductivity, non-isotropic electrical and thermal properties, improved mechanical properties, infrared radiation opacity, radar-absorbing and -deflecting properties, and other advantages.

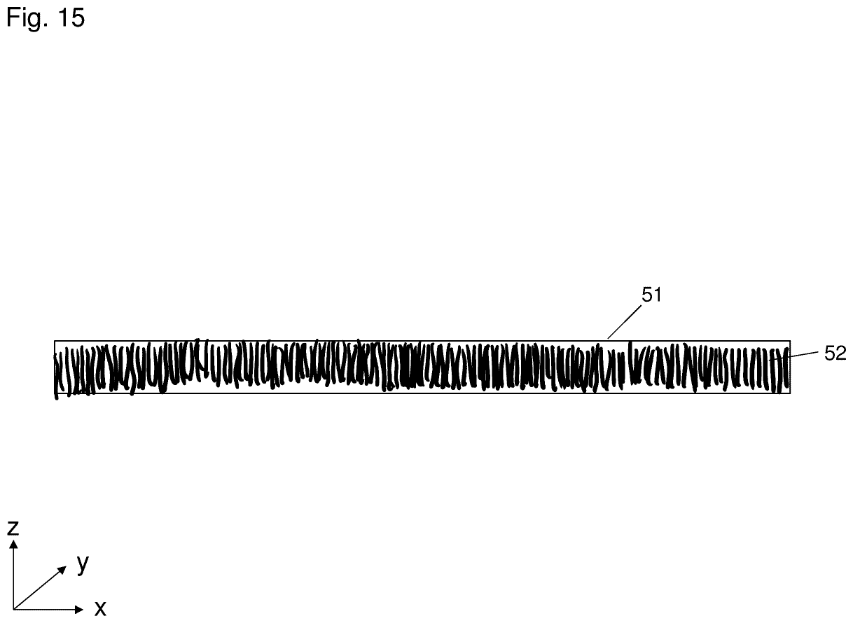

FIG. 15 depicts an example of a nanocomposite comprising a gel or aerogel material 51 and oriented nanostructures 52.

Layered aerogel composites comprising carbon aerogel materials (i.e., amorphous carbon, graphitic carbon, glassy carbon, activated carbon, carbon nanotubes, carbon nanofibers, diamond, graphene) with fiber sheets and multisheet plies also comprising carbon may be prepared. In some embodiments, a layered aerogel composite comprising polymer aerogel materials is pyrolyzed under an inert atmosphere (e.g., under Ar or N₂ at temperatures ranging from 400° C. to)2200° ° C.to provide a layered aerogel composite comprising carbon aerogel materials. In some embodiments, layered aerogel composites comprising carbon aerogels may be activated by electrochemical etching or high-temperature reaction with carbon dioxide to produce activated carbon aerogel materials. Layered aerogel composites comprising carbon aerogel materials may be useful for high-temperature ablative materials, tribological applications such as brake pads and high-performance clutches, and catalyst supports.

Various methods have been discovered for preparing layered aerogel composites. In one set of embodiments, the layered aerogel composite is prepared using liquid-phase aerogel precursors. In some embodiments, a fiber-containing sheet or multisheet ply is placed flat on a horizontal surface. Next, a liquid-phase aerogel precursor is added over the ply. A mold may be optionally used to contain the liquid in a desired shape. Another sheet or multisheet ply may then be added before the liquid-phase aerogel precursor has gelled, as the liquid-phase precursor is gelling, or after the liquid-phase precursor has gelled. This process may be repeated ad infinitum.

In some embodiments, the layered gel composite may then to be processed via diffusion-mediated steps such as solvent exchange, infiltration by a crosslinking agent, infiltration by a hydrophobing agent, or removal of substance from the gel's pore network. In some cases, added sheets or multisheet plies may stifle desired diffusion-mediate processes. To facilitate enhanced diffusion, an array of perforations or larger holes may be added to the sheets or multisheet plies to permit mass transport of liquid-phase substances through the various gel layers of the layered gel composite.

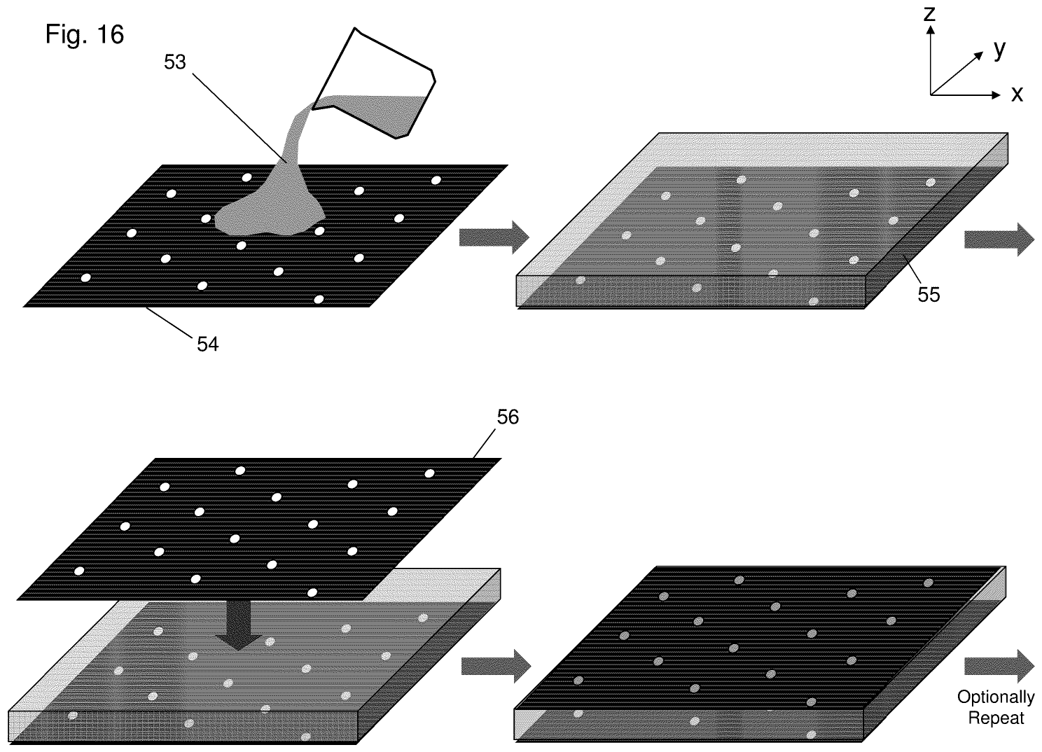

FIG. 16 shows adding a liquid-phase aerogel precursor 53 to a perforated sheet, multilayer ply, or plate 54 to form a liquid-phase, gel, or semi-gel layer 55, adding another perforated sheet, multilayer ply, or plate 56, and optionally repeating the process to form a layered gel composite. In some embodiments, the array of perforations or holes in such layers is staggered relative to other layers as to not result in alignment of perforations or holes in the through-thickness direction (z-axis) of the material. This may be advantageous for some applications, such as ballistics applications, to prevent weak spots in the layered aerogel composite.

In another set of embodiments, sheets or multisheet plies are preoriented and fixed at predetermined spacings in a mold. Next, a liquid-phase aerogel precursor is added. The layered gel composite may then be processed further to prepare a layered aerogel composite.

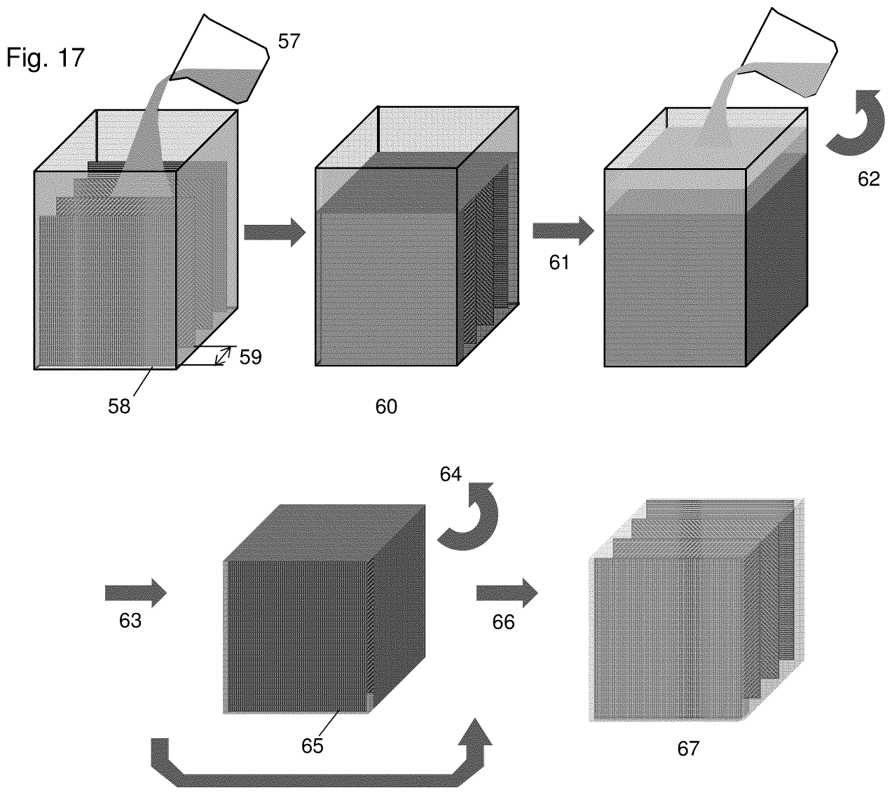

FIG. 17 schematically depicts pouring a liquid-phase aerogel precursor 57 into a mold containing sheets, multisheet plies, or plates 58 preoriented at fixed spacings 59; the liquid-phase acrogel precursor setting into a gel 60; optional gel aging 61; optional solution-phase processing (e.g., pore liquor exchange, crosslinking, functionalization, 62); optional mold removal 63; optional solution-phase processing 64 of the resulting layered gel composite 65; and subcritical or supercritical drying 66 to afford a layered acrogel composite 67. In a different set of embodiments, layered aerogel composites may be prepared by joining dry aerogel materials with fiber-containing sheets or multisheet plies. This may be accomplished by providing a sheet or multisheet ply, providing an adhesive layer, providing an aerogel, then invoking a bond to form.

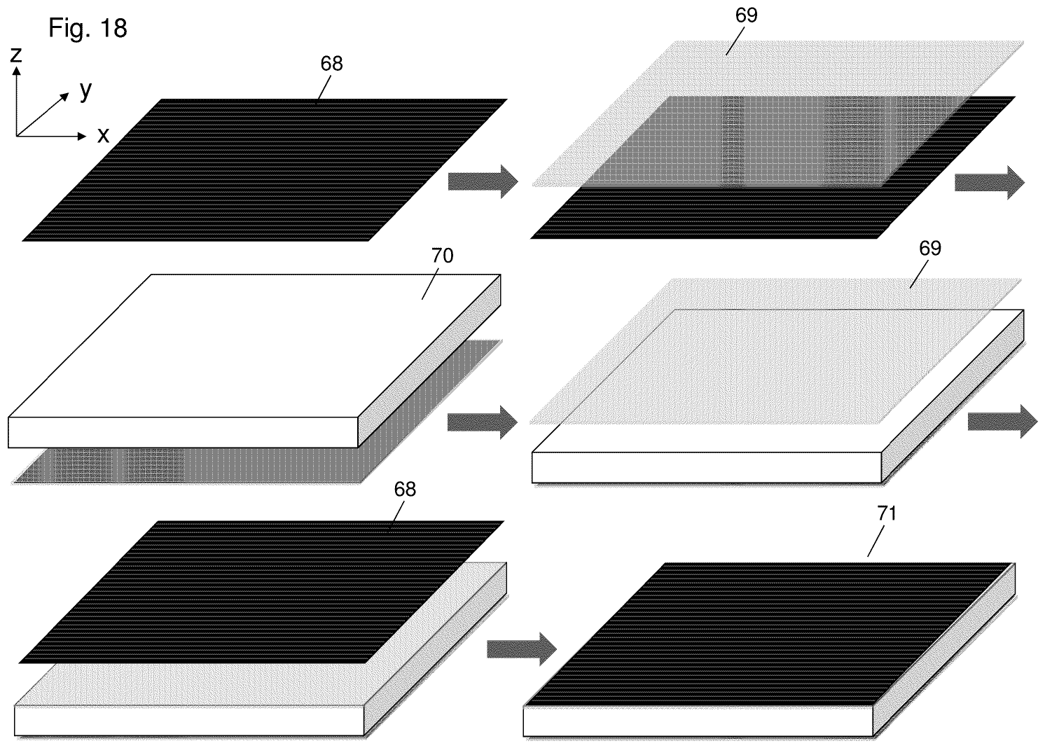

FIG. 18 schematically depicts how a fiber-containing sheet, multilayer ply, plastic sheet, or rigid plastic or ceramic plate 68 may be joined to an acrogel material 70 via an adhesive 69. In some preferred embodiments, 68 comprises an oriented fiber sheet. Bonding among layers in the layered aerogel composites may be accomplished through temperature, exposure to radiation, application of pressure, application of mechanical force, application of ultrasonic waves, hot pressing, or other means. In some preferred embodiments, the aerogel material comprises at least in part a polymer material.

In some embodiments, the aerogel material, non-acrogel plate, non-aerogel sheet, or non-aerogel multisheet ply may have incorporated on its surface reactive functional groups such as hydroxyl, amine, aminoalkyl, acyl chloride, oxirane, isocyanate, azide, carboxylic acid, or other reactive functional group. In some embodiments, a crosslinking agent may be used to bond said materials to each other. In other embodiments, an adhesive may be used. In still further embodiments, functional groups in a material in one layer (i.c., aerogel material, fiber-containing sheet or multisheet ply, non-aerogel plate, non-aerogel sheet) may be invoked through heat, light, pressure, ultrasonic waves, mechanical force, or other means to react directly with functional groups in a material in another layer, resulting in a bond.

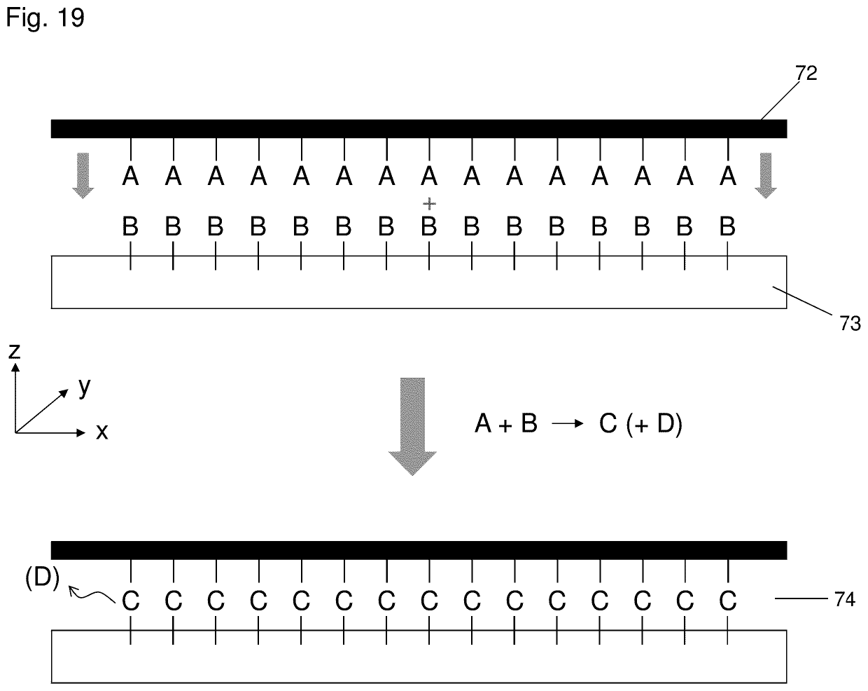

FIG. 19 depicts schematically how a fibrous sheet, multilayer ply, plastic plate, plastic sheet, or ceramic plate 72 with functional groups A may be joined to a gel or acrogel material 73 with functional groups B to form an interfacial bond 74 with chemical structure C (optionally releasing side product D). In some embodiments, an array of oriented nanostructures (e.g., vertically-aligned carbon nanotubes, aligned oxide nanofibers) is provided between two layers to aid in reinforcing the joint or bond between said layers. In some embodiments, an adhesive such as an epoxy, a polyurethane, a silicone, or other suitable adhesive may also be provided in conjunction with the array of oriented nanostructures.

In some embodiments, a reagent such as a monomer, a catalyst, an oxidizer, a reducer, a radical initiator, a vinyl-containing compound, a solvent, or other reagent may be infused into a fiber-containing sheet or multisheet ply prior to laying up of the layered aerogel composite or layered gel composite. Such reagents may interact with other reagents added onto such sheets or multisheet plies to facilitate in the formation of a gel, formation of a crosslinked surface layer over a gel's backbone, initiate crosslinking, stop crosslinking, initiate formation of an interpenetrating network, initiate formation of a polymer, initiate a reaction, stop a reaction, speed a reaction, slow a reaction, promote bonding to a sheet or multisheet ply, introduce a functional material into a gel network (e.g., an optically-active material, a hydrophobing agent, an infrared radiation opacifier, an electrochemically-active material, an electroless deposition reagent), or other function.

### EXAMPLES

### Example 1

### Preparation of Multilayer Plies from Fiber Felts, Cloths, Batting, Prepregs, or Sheets

Multilayer plies, including several layers or sheets of fibers composited together with a matrix or other binding agent, can be prepared for use in forming layered aerogel composites. In a typical preparation for a 12″×12″ area ply including 10 layers, 10 individual sheet pieces are cut to the desired size and any dust or stray fibers removed.

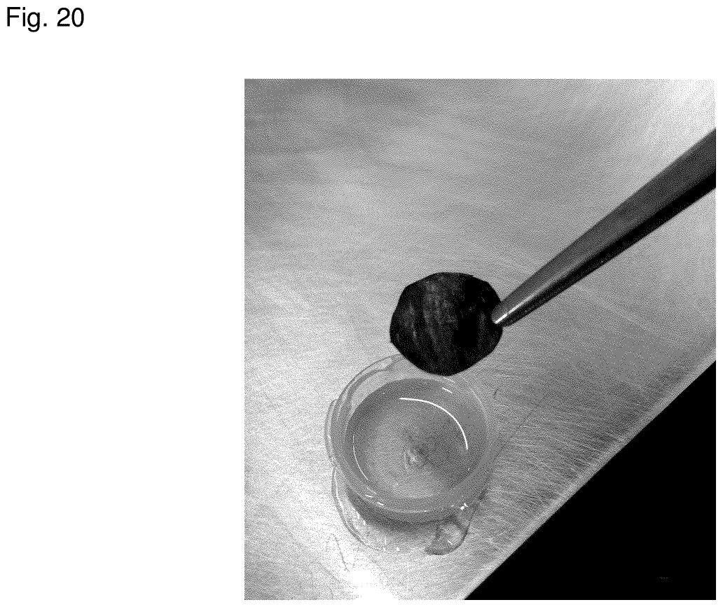

Examples of materials used for layering include fiber felts (e.g., Zicar Zirconia ZYF-50, Nanocomp Technologies CNT sheets), cloths (e.g., Hexcel® PrimeTex™ 200 GSM Plain Weave AS2C J 3K CP3000, Toho-Tenax® Tenax E HTA40 E13 3K, Zircar Zirconia ALW-30 alumina satin-weave cloth, E-glass or S-glass fiberglass cloth), prepreg (e.g., Hexcel® HexPly® AS4/8552), or other sheets (e.g., Honeywell® Spectra Shield®). The layers are dipped in an adhesive, such as a two-part epoxy (e.g., West System® Resin 105/Hardener 206, Hexcel® RTM6, Loctite® Epoxy Instant Mix 5 Minute, Loctite® Epoxy Heavy Duty) or a phenolic resin (e.g., Durite® SC-1008), and then layered in a mold (FIG. 20).

Viscosity of the adhesive/resin may adjusted by addition of acetone, acetonitrile, or other thinning solvents. Alternatively, a partially-crosslinked adhesive film may be applied. For oriented fiber sheets such as unidirectional carbon fiber pre-preg, the sheet orientation can be set in different directions to create various compliance profiles across the ply's thickness. The stack of layers is then cured by hot-pressing (e.g., in a 10-ton hot press) or set in an oven or autoclave and subjected to a heat-and-pressure cure cycle. The final ply is then trimmed to the requisite size and used in production of layered aerogel composites.

### Example 2

### Preparation of Multisheet Plies of Carbon Nanotube Sheets

Multisheet plies of carbon nanotube sheets are useful components for layering with mechanically strong aerogels such as polymer-crosslinked vanadia aerogels, hierarchically porous templated polymer-crosslinked silica aerogels, polyurea aerogels, polyurethane aerogels, carbon aerogels, and others. Such plies may be prepared by compositing materials including Buckypaper (Buckeye Composites, Kettering, OH), carbon nanotube sheets (Nanocomp Technologies Inc., Merrimack, NH) and collapsed nanotube forests (or VA-CNTs). Individual sheets may typically be on the order of 20-60 μm thick.

First, the carbon nanotube sheet material is cleaned by rinsing with an appropriate sequence of organic solvents and/or acid. For example, the sheet may be rinsed with acetone, then hexane, then 1.0 M nitric acid to remove residual surface-bound organic residues, carbon shells, and metallic catalysts. The carbon nanotube sheet material is then dried. Next, the carbon nanotube sheet material is prepregged. This may be done bonding it to a film of partially-cured adhesive (a prepreg film) with hot rollers, or by dipping it in an adhesive bath. Polyurethane adhesive is particularly suited. Multiple prepregged sheets (10 to 150 layers) are then stacked and pressed in a hot press under a pressure of 5 to 20 tons/in². The final pressed multisheet ply may then be layered as described in other examples below.

### Example 3

### Preparation of Layered Aerogel Composites Using a Frame

Multiple layers of material can be incorporated simultaneously into a layered aerogel composite by using a holding frame to precisely space, position, and optionally tension each layer. Frames can be of multiple designs, but in general include a rectangular framework or gantry into which individual layers of material can be inserted.

Frames can include of a single construction, or be built up from several smaller frames stacked and locked onto each other to form a multi-layer array. Individual layers are held in place with fasteners, adhesive, clamps, or friction between the smaller frames. Frames can be built to flex or extend so that tension can be placed on the layers to keep them taut and level during gel casting. To assist in percolation of the liquid-phase sols during gel casting, holes or perforations may be made in the sheets prior to insertion in the frame or while in the frame using any number of physical processes including punching, milling, or laser cutting. The perforations allow better flow of sol between layers, assisting in the even distribution and complete encapsulation of reinforcing sheets/plies within the gel matrix.

### Example 4

### Synthesis of Layered Aerogel Composites Comprising Alternating Layers of Polymer-Crosslinked Vanadia Aerogel and Nanotube Sheets/Multisheet Plies: Wet Method

Nanotube felts, weaves or sheets can be used for aerogel reinforcement, including those produced from carbon nanotubes (CNTs) and boron nitride nanotubes (BNNTs). Some suitable materials include Buckypaper (Buckeye Composites, Kettering, OH), carbon nanotube sheets (Nanocomp Technologies Inc., Merrimack, NH), collapsed nanotube forests (or VA-CNTs), or multisheet plies prepared from these materials.

In a typical preparation for a 12″×12″ area of composite at nominal 1-mm thickness, a mold or frame is prepared to hold the requisite sheets/felts or multisheet plies. The nanotube felt or multisheet ply is set at the bottom of the mold, or in the case of the frame, the requisite number of sheets is strung and held in tension within the frame as described in Examples 1 and 2.

A sol is prepared as follows: a solution (Solution 1) of 54.5 mL (3.0 mol) deionized water and 26.8 mL (365 mmol) acetone is prepared with stirring. A second solution (Solution 2) including 11.5 mL (48.9 mmol) vanadium(V) oxytripropoxide is also prepared. Both solutions are cooled to approximately −78 ° C.in an acetone/dry ice bath with constant agitation to break up ice crystals and produce an even, smooth slurry. Solution 1 is removed from cooling and agitated until all of the solids dissolve. Immediately then Solution 1 is poured into Solution 2 to produce the sol and stirred vigorously for several minutes. The sol is then poured into the mold/frame with the sheets after which the mold/frame is sealed to prevent evaporation loss. The sol is allowed to stand at ambient conditions in the mold/frame until gelation. If the composite is being generated by horizontal layering (as opposed to a frame), additional layering of sheets/felts or multisheet plies followed by application of sol-gel layers may be repeated. The composite is then set in an air-tight, sealed container and allowed to age for 5 days. Next, the composite is de-molded (removed from the frame) and set into an exchange tank with 464 mL (5× the gel volume) virgin acetone. The acetone is gently agitated to facilitate mixing/diffusion of the gel effluent but not to the extent that it jostles or damages the gel. The acetone volume is fully exchanged 4×, once every 1 day.

A solution (Solution 3) of 464 mL (5× the gel volume) virgin acetone and 1.1 mol diisocyanate (e.g., Bayer® MaterialScience Desmodur® N3200) is prepared in an exchange tank. The composite is transferred to Solution 3 and allowed to exchange for 40 h with gentle agitation. The exchange tank is sealed air-tight and transferred to an oven where it is heated (with the composite inside) for 72 h at 50° C. with gentle agitation. The composite is then exchanged in 464 mL virgin acetone. The acetone volume is fully exchanged 4×, once every 1 day. The composite is then transferred to an autoclave and exchanged with liquid carbon dioxide to remove residual acetone. The gel is then supercritically dried to prepare the final layered aerogel composite. This formulation can be scaled to produce larger areas and thicknesses of layered aerogel composites. Different gel formulations can be/used as well.

### Example 5

### Synthesis of Layered Aerogel Composites Comprising Alternating Layers of Hierarchically Porous Templated Polymer-Crosslinked Silica Aerogel and Nanotube Sheets/Multisheet Plies: Wet Method

The process described in Example 4 can be performed with a gel precursor suitable for making a layered aerogel composite comprising hierarchically porous templated silica aerogel for the aerogel layers instead of vanadia-based aerogel layers.

A sol is prepared as follows: a solution of 4.0 g Pluronic P123 (BASF) and 12 g of 1.0 M aqueous nitric acid is prepared and set stirring. 10.42 mL (74.9 mmol) 1,3,5-trimethylbenzene is added. The solution is cooled to 0° C. and stirred for 30 min. Next, 20.0 mL (131.7 mmol) of tetramethoxysilane is added and stirred vigorously for 10 min to produce a sol. The sol is poured into the mold/frame and sealed to prevent evaporation loss and allowed to stand at 60° C. until gelation. If the composite is being generated by horizontal layering (as opposed to a frame), additional layering of sheets/felts or multisheet plies followed by application of sol-gel layers may be repeated. The composite is then aged at 60° C. for 4 h. The composite is then de-molded and set into an exchange tank with 371 mL (4× the gel volume) of ethanol. The ethanol is agitated gently to facilitate mixing/diffusion of the gel effluent but not to the extent that it jostles or damages the gel. The ethanol volume is fully exchanged 2×, once every 8 hours. The composite is then exchanged with 600 mL acetonitrile using a Soxhlet-type, re-distillation process that is allowed to run for 2 days. The composite is then exchanged into 371 mL acetone. The acetone volume is fully exchanged 4×, once every 8 hours.

A solution (Solution 3) is then prepared of 371 mL (445.2 g) propylene carbonate and 0.13 mol of a diisocyanate (e.g., Desmodur N3200). The composite gel is placed into Solution 3 and allowed to exchange for 24 hour. The exchange tank is then sealed air-tight and set into an oven or autoclave at 55 ° C.for 3 days. The composite is then exchanged into 371 mL acetone for 8 h. The acetone volume is fully exchanged 3× more, once every 8 h. The composite is then transferred to an autoclave and exchanged with liquid carbon dioxide to remove residual acetone. The composite is then supercritically dried to prepare the final layered aerogel composite.

### Example 6

### Synthesis of Layered Aerogel Composites Comprising Alternating Layers of Polymer-Crosslinked Vanadia Aerogel and Nanotube Sheets/Multisheet Plies: Dry Method

Layered aerogel composites can be formed from prefabricated dry aerogel monoliths (sheets or layers) as well. Polymer-crosslinked vandia (“x-vanadia”) aerogels can be bonded to nanotube felts, weaves or sheets, including those produced from carbon nanotubes (CNTs), boron nitride nanotubes (BNNTs). Some suitable materials include Buckypaper (Buckeye Composites, Kettering, OH), carbon nanotube sheets (Nanocomp Technologies Inc., Merrimack, NH), collapsed nanotube forests (or VA-CNTs), or multisheet plies prepared from these materials. In a typical preparation for a 12″33 12″ area of composite at nominal 1-mm thickness, a mold or frame is prepared to hold the requisite felts or multisheet plies. The mold or frame is designed such that the monolith can be removed by either sliding out of the mold or removing the bottom of the mold so as to make it readily easy to manipulate the thin aerogel monolith. The sol is prepared as follows: a solution (Solution 1) of 54.5 mL (3.0 mol) deionized water and 26.8 mL (365 mmol) acetone is prepared to formed by stirring.

A second solution (Solution 2) including 11.5 mL (48.9 mmol) vanadium(V) oxytripropoxide is prepared. Both solutions are cooled to approximately −78 ° C.in an acetone/dry ice bath with constant agitation to break up ice crystals and produce an even, smooth slurry. Solution 1 is removed from cooling and agitated until all of the solids dissolve. Immediately then Solution 1 is poured into Solution 2 to produce the sol, and stirred vigorously for several minutes. The sol is then poured into the mold and sealed to prevent evaporation loss. The sol is allowed to sit at ambient until gelation. The composite is then set in an air-tight, sealed container and allowed to age for 5 days. The gel is then de-molded (removed from the mold) and set into an exchange tank with 464 mL (5× the gel volume) virgin acetone. The acetone is agitated gently to facilitate mixing/diffusion of the gel effluent but not to the extent that it jostles or damages the gel. The acetone volume is fully exchanged 4×, once every 1 day.

A solution (Solution 3) of 464 mL (5× the gel volume) virgin acetone and 1.1 mol diisocyanate (e.g., Bayer® MaterialScience Desmodur® N3200) is prepared in an exchange tank. The gel is transferred to Solution 3 and allowed to exchange for 40 h with gentle agitation. The exchange tank is sealed air-tight and transferred to an oven where it is heated (with the gel inside) for 72 h at 50° C. with gentle agitation. The gel is then exchanged in 464 mL virgin acetone. The acetone volume is fully exchanged 4×, once every 1 day. The gel is then transferred to an autoclave and exchanged with liquid carbon dioxide to remove residual acetone. The gel is then supercritically dried to prepare the final aerogel monolithic sheets.

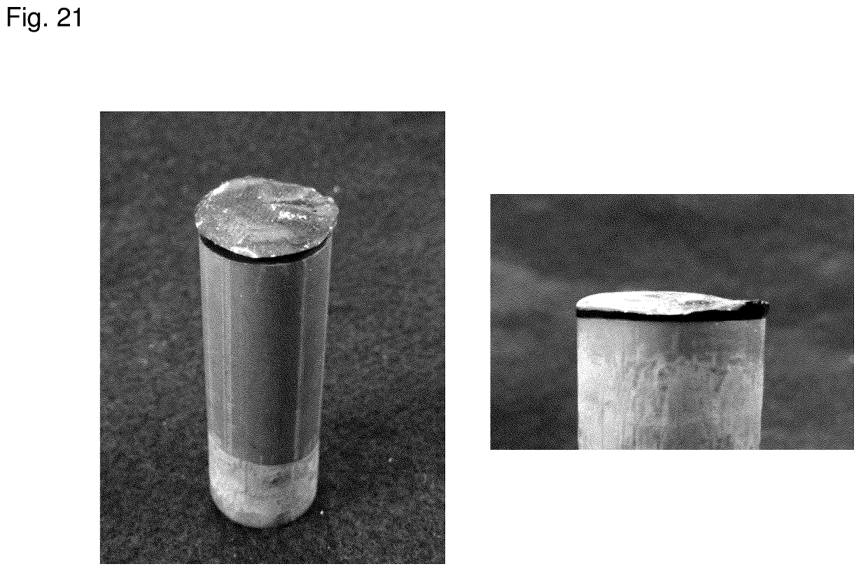

The layered aerogel composite is produced by sequentially securing nanotube sheets to x-vanadia aerogel sheets (FIG. 21). In a typical preparation, for 12″×12″ composite, an approximately 12″×12″ x-vanadia aerogel monolith is coated on its top surface with a thin layer of adhesive (e.g. an epoxy such as those described in Example 1, a cyanoacrylate, or other suitable adhesive). The adhesive can be coated by brushing, spraying, dipping, rolling, or any other physical method for applying liquid to the felt surface. The adhesive layer is applied such that the adhesive wets the top surface of the aerogel but does not saturate the entire sheet. A 12″×12″×0.25″ multisheet nanotube ply is then coated on one surface with a thin layer of adhesive in a similar same manner.

Alternatively, a single-sheet felt can be used in which case the entire felt can be saturated (impregnated) with adhesive via capillary-driven wetting. The nanotube ply or sheet is then inverted and set atop the X60 aerogel. A press (cold or hot) is used to apply enough pressure to push and hold the nanotube ply or sheet onto the aerogel. The compression force is determined by trial and error. The composite is held in press for 8-24 h to cure. The composite can also be placed in an oven or autoclave and subject to heat-and-pressure cycles to cure. Weight maybe applied to the composite during curing to facilitating bonding of the two elements during curing.

Multi-layer composites can then be produced by continuously repeating the above process to build stacks of nanotube plies/sheets and x-vanadia aerogel. Composites with more layers and with greater thicknesses are generally better suited for absorbing impact from projectiles such as bullets or shrapnel.

### Example 7

### Synthesis of Layered Aerogel Composites Comprising Alternating Layers of Hierarchically Porous Templated Polymer-Crosslinked Silica Aerogel and Nanotube Sheets/Multisheet Plies: Dry Method

Similar to Example 6, layered aerogel composites comprising alternating layers of hierarchically porous templated polymer-crosslinked silica aerogel and nanotube sheets and/or multisheet plies may be prepared with prefabricated dry aerogel layers instead of wet gel precursors. The general lay-up process used in Example 5 is performed using separately molded and dried aerogel monoliths prepared with the gel chemistry used to prepare hierarchically porous templated polymer-crosslinked silica aerogel material as described in Example 5. Multi-layer composites can then be produced by continuously repeating the above process to build stacks of nanotube plies/sheets and hierarchically porous templated polymer-crosslinked silica aerogel. Composites with more layers and with greater thicknesses are generally better suited for absorbing impact from projectiles such as bullets or shrapnel.

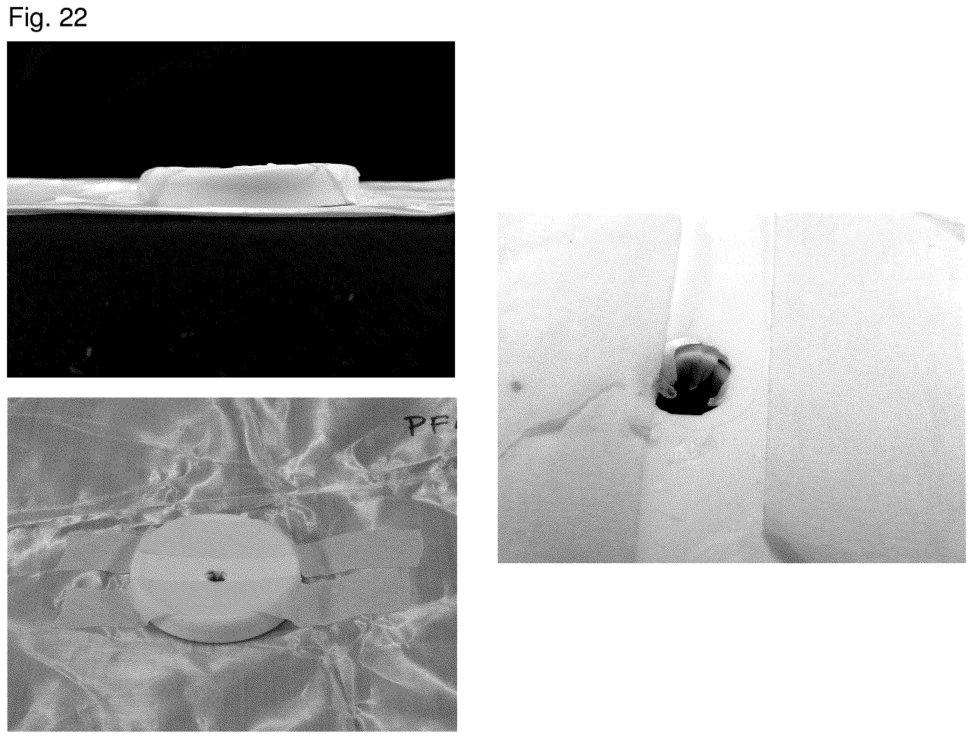

FIG. 22 shows an example of a layered aerogel composite made of numerous alternating layers of aerogel and carbon nanotube plies and bonded to a Spectra® (ultrahigh molecular weight polyethylene) fiber sheet, suitable for ballistics applications such as bullet-proof vests.

### Example 8

### Preparation of Layered Aerogel Composites Comprising Carbon Fiber Reinforced Plastics and Polyurea Aerogels: Dry Method

Layered aerogel composites can be formed from prefabricated aerogel monoliths (sheets or layers) of mechanically strong polyurea aerogels, which are then bonded to sheets of carbon fiber sheets or woven fabrics, or composites or multilayer plies formed from carbon fiber. In a typical preparation, a polyurea aerogel is made as follows. A solution of 94 mL (1.28 mol) and 33.6 mmol of a diisocyanates or triisocyanate (e.g. Bayer® MaterialScience Desmodur® N3300) is prepared with vigorous stirring. To the solution is added 0.88 mL (48.8 mmol) of deionized water followed by 0.26 mL (1.9 mmol) of triethylamine catalyst.

The solution is stirred vigorously for 1 min and then poured into a mold and sealed to prevent evaporation loss. The sol is allowed to stand at ambient conditions until gelation. The gel is then placed in an air-tight, sealed container and allowed to age for 24 hr. Next, the gel is de-molded and set into an exchange tank with 371 mL (4× the gel volume) virgin acetone. The acetone is agitated gently to facilitate mixing/diffusion of the gel effluent but not to the extent that it jostles or damages the gel. The acetone volume is fully exchanged 3×, once every 1 day. The gel is then transferred to an autoclave and exchanged with liquid carbon dioxide to remove residual acetone. The gel is then supercritically dried to produce an aerogel. This formulation can be scaled to produce larger areas or thicknesses.

Next, a layered aerogel composite is produced by sequentially securing carbon fiber sheets to the polyurea aerogel monolith. In a typical layup, the aerogel monolith is coated on its top surface with a thin layer of adhesive (e.g. epoxy based resin). The adhesive can be coated by brushing, spray, dipping, rolling or any other physical method for applying liquid to the aerogel surface. The adhesive layer is applied such that the adhesive liquid wets the top surface of the aerogel but does not saturate the entire monolith.

Alternatively a partially-crosslinked adhesive film can be applied. A sheet of unidirectional carbon fiber prepreg (e.g., Hexcel® HexPly® AS4/8552) or multilayer ply (prefabricated or prepared according to standard carbon fiber compositing techniques) is then applied to the adhesive layer. The process is repeated for the back side of the aerogel. The composite is then subjected to heat-and-pressure cycles in an autoclave or cured in a hot press. This process can be repeated continuously to built up larger stacks of carbon fiber/aerogel.

### Example 9

### Preparation of Layered Aerogel Composites Comprising Airloy® Aerogels and Carbon Fiber

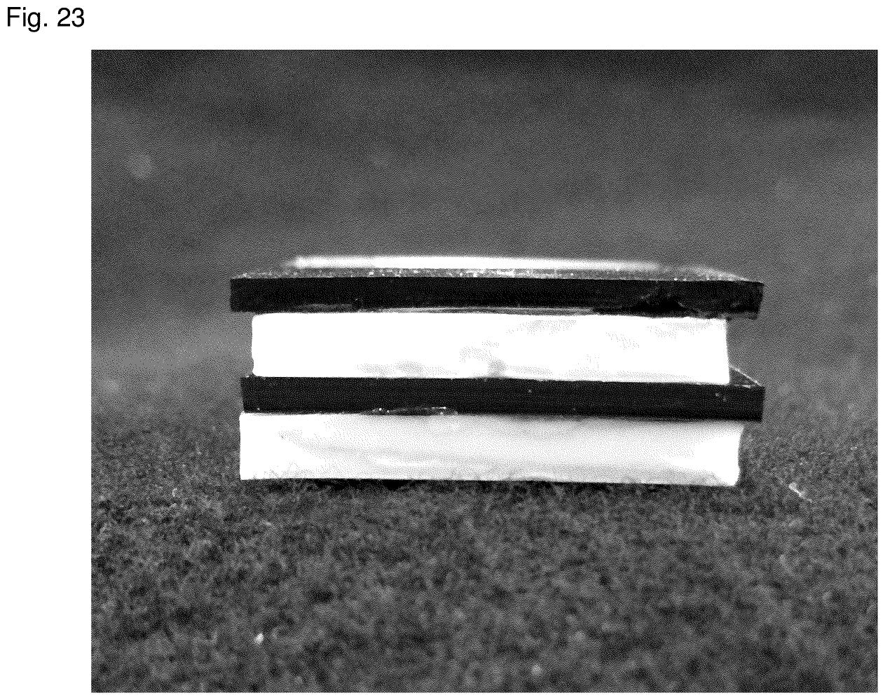

The process described in Example 8 may be performed using Airloy® Ultramaterials (Aerogel Technologies, Boston, MA) for the aerogel layers. Suitable materials include Airloy X103-L (˜0.1 g/cm³), X103-M (˜0.2 g/cm³), X103-H (˜0.45 g/cm³), and other X100-series materials; Airloy X110-series materials; Airloy X50-series materials; and other Airloy materials. Thinner composites (with thinner Airloy cores and thinner carbon fiber outer skins) may exhibit some flexibility. FIG. 23 shows an example of a multilayer aerogel composite prepared with Airloy X103-M for the aerogel layers.

### Example 10

### Preparation of Layered Aerogel Composites Comprising Carbonizable Layers and Hafnia-Aerogel-Infiltrated Felts

Layered aerogel composites can be formed by sequentially layering phenolic resin sheets or plates with hafnia-aerogel-impregnated ceramic fiber felts. The phenolic resin sheets or plates may comprise one or more of a phenolic resin, carbon fibers, oxidized poly(acrylonitrile) fibers, or other fibers, and may be rigid or flexible. Hafnia-aerogel-impregnated felts are produced as follows. A 2-mm thick zirconia or yttrium-stabilized zirconia (YSZ) felt (Zircar Zirconia, Florida, NY) is cut and set into a mold or frame of the requisite size. Different thicknesses and compositions of felt may also be used.

A hafnia sol is prepared as follows. To 71.9 mL deionized water is added 11.3 g (35.3 mmol) hafnium(IV) chloride in small increments with vigorous stirring. The resulting solution is cooled in an ice bath with stirring until it reaches 0° ° C. 26.0 mL (0.37 mol) of propylene oxide is then added dropwise to the stirring solution to form the sol. The sol is stirred for 1 min and then poured onto the ceramic fiber felt in the mold/frame and sealed to prevent evaporation loss. The sol-infiltrated fabric is allowed to stand at ambient conditions until gelation. The gel-impregnated felt is then set in an air-tight, sealed container and allowed to age for 12 hours. The gel-impregnated felt is then de-molded and set into an exchange tank with 371 mL (4× the gel volume) of methanol. The methanol is agitated gently to facilitate mixing/diffusion of the gel effluent but not to the extent that it jostles or damages the gel. The methanol volume is fully exchanged 3×, once every 24 hours. The gel-impregnated felt is then transferred to an autoclave and exchanged with liquid carbon dioxide to remove residual methanol. The gel is then supercritically dried to prepare the final hafnia-aerogel-impregnated felt. The hafnia-aerogel-impregnated felt is finally annealed at 1100° C. in air for several hours.

A similar process may be used to prepared zirconia-aerogel-infiltrated felt or titania-aerogel-infiltrated felt by swapping the metal salt precursor for the appropriate analog and tailoring the stoichiometries accordingly.

A layered aerogel composite is produced by sequentially adhering phenolic sheets to hafnia aerogel impregnated felts. In a typical layup, the hafnia-aerogel-impregnated felt is coated on its top surface with a thin layer of adhesive (e.g. epoxy based resin). The adhesive can be coated by brushing, spray, dipping, rolling or any other physical method for applying liquid to the felt surface. The adhesive layer is applied such that the adhesive liquid wets the top surface of the felt but does not saturate the entire hafnia-aerogel-impregnated felt.

Alternatively a partially-crosslinked adhesive film may be applied. A phenolic sheet or plate is then applied to the adhesive layer and a press (cold or hot) is used to apply a small pressure to the composite. The composite is held in the press for 8-24 hour to cure. The composite can also be placed in an oven or autoclave and annealed to cure. Multi-layer composites can be produced by repeating the above process to build up stacks of hafnia-aerogel-impregnated felt/and phenolic sheets/plates.

Such layered aerogel composites provide alternating ablative and high-temperature insulating functions and are suitable for thermal protection system applications such as spacecraft reentry and shielding energetic flames and explosives.

### Example 11

### Layered Aerogel Composite for Thermal Protection Systems

A layered aerogel composite comprising alternating layers of a carbonizable aerogel and an oxide-based aerogel material may be prepared. Mechanically strong carbonizable aerogels such as aromatic polyurea aerogels are particularly desirable. Mechanically strong carbonizable polyurea aerogels can be prepared as follows. A solution of 94 mL (1.28 mol) and 33.6 mmol of an aromatic triisocyanate (e.g. Bayer® MaterialScience Desmodur® RE) is prepared with vigorous stirring. To the solution is added 0.88 mL (48.8 mmol) of deionized water followed by 0.26 mL (1.9 mmol) of triethylamine catalyst. The solution is stirred vigorously for 1 min and then poured into a mold and sealed to prevent evaporation loss. The sol is allowed to stand at ambient conditions until gelation. The gel is then placed in an air-tight, sealed container and allowed to age for 24 hr. Next, the gel is de-molded and set into an exchange tank with 371 mL (4× the gel volume) virgin acetone. The acetone is agitated gently to facilitate mixing/diffusion of the gel effluent but not to the extent that it jostles or damages the gel. The acetone volume is fully exchanged 3×, once every 1 day. The gel is then transferred to an autoclave and exchanged with liquid carbon dioxide to remove residual acetone. The gel is then supercritically dried to produce an aromatic polyurea aerogel. This formulation can be scaled to produce larger areas or thicknesses.

The aromatic polyurea aerogel can then be bonded to the hafnia-aerogel-impregnated felt described in Example 10 with epoxy and layed up into a multilayer aerogel composite. This configuration provides composites with a lower density than composites described in Example 10.

### Example 12

### Reinforcement of Aerogels and Gels with Vertically-Aligned Carbon Nanotube Arrays

Aerogels and gels reinforced with vertically-aligned carbon nanotube arrays may be prepared. Such carbon nanotube arrays can also be used to aid in joining aerogel and gel layers to other aerogel and gel materials, or other materials.

Carbon nanotube arrays may be grown as follows. First, a catalyst-coated substrate is prepared. The substrate an be a silicon wafer with a 10-nm alumina layer covered with 1 nm of Fe prepared through e-beam evaporation, or alternatively a stainless steel substrate (304 or similar) covered with a multimicron-thick (or less) layer of alumina prepared through repeated sol-gel deposition and baking. Numerous other catalyst-coated substrates suitable for carbon nanotube growth work as well.

Chemical vapor deposition growth of carbon nanotubes is then performed. All gases used are ultrahigh purity grade (Airgas, 99.999+%). The substrate is then inserted into a 1″-diameter fused quartz tube (about 75% down the length of the tube) placed inside an electric clamshell furnace (Lindberg/Blue-M MiniMite®). Next, a flow of argon gas (100 sccm) is added to displace air after which a flow of hydrogen (100 sccm). The substrate is then heated to a temperature of 720° ° C.over the course of 7 min. Once at temperature, a flow of ethylene (100 sccm) is added. After 10-40 min, the ethylene is turned off and the substrate is optionally allowed to anneal under hydrogen/argon flow for another 5 min. After this, the hydrogen is turned off, the argon flow is increased to 400 sccm, and the furnace is turned off. The substrate is then allowed to cool to ambient conditions over the course of 20-60 min. The resulting substrate should now bear an array of vertically-aligned multiwall carbon nanotubes (or forest) ranging from about 100 μm to 1 mm in height which can be delaminated either mechanically or with the assistance of adhesive tape.

To prepare gels and aerogels reinforced with vertically-aligned carbon nanotubes, the forest can then be placed into a sol undergoing gelation. Alternatively, a sol can be poured over the forest. Upon gelation, the resulting gel composite can be aged, solvent exchange, and supercritically or subcritically dried.

The forest can also be placed part-way into a sol undergoing gelation to produce a gel with a partially-exposed array of vertically-aligned carbon nanotubes. This partially-exposed array may then serve as a reinforcing layer for bonding the gel or resulting aerogel material to other materials as described above.

These processes are compatible with any of a number of standard sol-gel preparations including those described in the previous examples, for example, preparing polymer-crosslinked vanadia and silica aerogels and polyurea aerogels.

Having thus described several aspects of various embodiments of the present disclosure, it is to be appreciated various alterations, modifications, and improvements will readily occur to those skilled in the art. Such alterations, modification, and improvements are intended to be part of this disclosure, and are intended to be within the spirit and scope of the present disclosure. Accordingly, the foregoing description and drawings are by way of example only.

What is claimed is:

1. A structure comprising bonded alternating layers of at least an aerogel material and at least one of a fibrous sheet, a plastic sheet, a plastic plate, a ceramic sheet, a ceramic plate, and a multilayer ply, the multilayer ply comprising multiple fibrous sheets bonded together.

2. The structure of claim 1, wherein the aerogel material exhibits a compressive modulus greater than about 1 MPa.

3. The structure of claim 1, wherein the aerogel material exhibits a compressive yield strength greater than about 0.1 MPa.

4. The structure of claim 1, wherein the structure comprises two or more aerogel materials with different compressive moduli.

5. The structure of claim 1, wherein the aerogel material comprises a contiguous oxide network in which a crosslinker is bound to the surfaces of said oxide network.

6. The structure of claim 5, wherein the oxide network comprises silica, vanadium oxide, a metal oxide, a metalloid oxide, a non-metal oxide.

7. The structure of claim 1, wherein the aerogel material comprises carbon, amorphous carbon, single-wall carbon nanotubes, multiwall carbon nanotubes, graphene, graphitic nanoribbons, graphite, activated carbon, nanodiamond, diamond, diamond-like carbon, glassy carbon.

8. The structure of claim 1, wherein the aerogel material comprises an organic polymer.

9. The structure of claim 8, wherein the polymer comprises at least an isocyanate, a polyurea, a polyurethane, a polyimide, a polyamide, a polycarbonate, a polyacrylamide, a polyacrylate, a polycyanurate, a polyfurfural alcohol, a polystyrene, a polyvinyl alcohol dialdehyde, an epoxy, polyethylene, polypropylene, polybutadiene, poly(methyl methacrylate), polyacrylonitrile, acetic acid, a poly(norbornene), a poly(cyclopentadiene), a poly(3,4-ethylenedioxythiophene), acetic acid, resorcinol formaldehyde, phenol formaldehyde, melamine formaldehyde, cresol formaldehyde, phenol furfuryl alcohol, agar agar, agarose.

10. The structure of claim 1, wherein the aerogel material comprises at least a metal, a metalloid, a carbide, a nitride, a silicide, a chalcogenide.

11. The structure of claim 10, wherein the aerogel material comprises at least boron, boron carbide.

12. The structure of claim 1, wherein the aerogel material comprises a network of assembled nanostructures.

13. The structure of claim 12, wherein the aerogel material comprises at least a quantum dot, a nanoparticle, a nanofiber, a nanoplatelette, a nanosheet, a nanoribbon.

14. The structure of claim 1, wherein the aerogel material comprises silicon carbide.

15. The structure of claim 1, wherein the fibrous sheet comprises polyethylene.

16-54. (canceled)

55. A structure comprising alternating layers of aerogel material wherein said layers are joined to each other by an array of oriented nanostructures.

56. A method for fabricating a layered aerogel composite comprising:
providing a first layer, the layer comprising at least a fibrous sheet or a multilayer laminate;
applying a second layer to the first layer, the layer comprising an aerogel material;
applying a third layer to the second layer, the layer comprising another fibrous sheet or multilayer laminate;
bonding or joining the first layer to the second layer; and
bonding or joining the second layer to the third layer.

57-79. (canceled)
